(19) United States
(12) Patent Application Publication
(10) Pub. No.: US 2025/0042525 A1
(43) Pub. Date: Feb. 6, 2025

(54) ACTUATOR

(71) Applicant: Dometic Marine Canada Inc., Richmond (CA)

(72) Inventors: Davor Baros, New Tecumseh (CA); Michael Brent Ure, Delta (CA)

(21) Appl. No.: 18/922,639

(22) Filed: Oct. 22, 2024

Related U.S. Application Data
(63) Continuation-in-part of application No. 17/509,715, filed on Oct. 25, 2021, now Pat. No. 12,122,483.
Application No. 17/509,715 is a continuation-in-part of application No. 16/590,363, filed on Oct. 1, 2019, now Pat. No. 11,155,322.
(60) Provisional application No. 62/739,836, filed on Oct. 1, 2018.

(51) Int. Cl. B63H 20/22; B63H 20/10; B63H 20/32

(52) U.S. Cl. CPC B63H 20/22; B63H 20/10; B63H 20/32

(57) ABSTRACT

An actuator includes a drive body including a torque-transfer surface configured to receive a torque. The actuator further includes: a drivable body including an output shaft; a first bearing configured to transfer thrust forces from the output shaft in a first direction; and a second bearing configured to transfer thrust forces from the output shaft in a second direction. At least the first bearing extends in a radial dimension beyond the torque-transfer surface. The drive body may be engaged with the drivable body through at least one ball such that rotation of the drive body causes movement of the output shaft. The at least one ball may engage with the drive body over a greater extent along an axis of rotation than with the drivable body.

### CROSS-REFERENCE TO RELATED APPLICATIONS

This application is a continuation-in-part of U.S. patent application Ser. No. 17/509,715 filed Oct. 25, 2021, which is a continuation-in-part of U.S. patent application Ser. No. 16/590,363 filed Oct. 1, 2019, which claims the benefit of U.S. provisional patent application No. 62/739,836 filed Oct. 1, 2018.

### FIELD

The present disclosure relates to actuators.

### RELATED ART

U.S. Pat. No. 5,881,666 which issued on Mar. 16, 1999, in the name of Crews discloses a trim tab actuator. There is a ram adapted to be connected at a first end to the trim tab and connected at a second end to a drive. The ram has a longitudinal portion equal to at least the maximum stroke of the ram and is received in the longitudinal bore of which longitudinal bore has a length equal to or greater than the maximum stroke of the ram. An inboard seal is disposed between the ram and bore. The inboard seal is positioned inboard of the longitudinal portion of the ram when the ram is retracted.

### SUMMARY

Embodiments of the present disclosure may include a watertight electric actuator for use as part of a trim tab assembly or wake gate assembly.

According to one embodiment, there is provided an actuator comprising a housing and a drive tube assembly disposed within the housing. The drive tube assembly includes a drive tube provided with internal threads, a piston nut provided with external threads which threadedly engage the internal threads of the drive tube, and an output shaft connected to the piston nut. A motor rotates the drive tube to cause the piston nut to reciprocate along a length of the drive tube and the output shaft to reciprocate relative to the housing. There are bearings which transmit axial loads from the drive tube to the housing and transmit radial loads from the drive tube to the housing.

The piston nut may be threadedly connected to the output shaft. A diameter of the external threads of the piston nut may be larger in diameter than threads that threadedly connect the piston nut to the output shaft. There may be a planetary gear reduction coupling the motor to the drive tube. There may be a vent tube allowing fluid communication between the atmosphere and an interior of the housing. The actuator may be watertight. The actuator may be part of a trim tab assembly or a wake gate assembly.

According to another embodiment, there is provided an actuator comprising a housing and a drive shaft assembly disposed within the housing. The drive shaft assembly includes a drive shaft provided with external threads, a piston nut provided with internal threads which threadedly engage the external threads of the drive shaft, and an output shaft connected to the piston nut. A motor rotates the drive shaft to cause the piston nut to reciprocate along a length of the drive shaft and the output shaft to reciprocate relative to the housing. There are bearings which transmit axial loads from the drive shaft to the housing and transmit radial loads from the drive shaft to the housing.

The piston nut may be threadedly connected to the output shaft. A diameter of the internal threads of the piston nut may be larger in diameter than threads that threadedly connect the piston nut to the output shaft. There may be a planetary gear reduction coupling the motor to the drive shaft. There may be a vent tube allowing fluid communication between the atmosphere and an interior of the housing. The actuator may be watertight. The actuator may be part of a trim tab assembly or a wake gate assembly.

According to at least one embodiment, there is provided an actuator comprising: a housing; and a drive body rotatably coupled to the housing such that the drive body is rotatable relative to the housing around a drive-body axis of rotation. The drive body comprises: a threaded surface; a first thrust-transfer surface extending transversely to the drive-body axis of rotation and facing a first direction along the drive-body axis of rotation; a second thrust-transfer surface extending transversely to the drive-body axis of rotation and facing a second direction, opposite the first direction, along the drive-body axis of rotation; and a torque-transfer surface configured to receive a torque around the drive-body axis of rotation to rotate the drive body relative to the housing and around the drive-body axis of rotation. The actuator further comprises: a drivable body comprising an output shaft and a threaded surface, the threaded surface of the drivable body threadedly engaged with the threaded surface of the drive body such that rotation of the drive body relative to the housing and around the drive-body axis of rotation causes movement of the output shaft relative to the housing and along the drive-body axis of rotation; a first bearing facing the first thrust-transfer surface and configured to transfer, to the housing, thrust forces from the output shaft in the first direction; and a second bearing facing the second thrust-transfer surface and configured to transfer, to the housing, thrust forces from the output shaft in the second direction. At least the first bearing extends, in a radial dimension from the drive-body axis of rotation, beyond the torque-transfer surface.

In some embodiments, the second bearing extends, in the radial dimension from the drive-body axis of rotation, beyond the torque-transfer surface.

In some embodiments, the drive body is a drive tube, the threaded surface of the drive body is on an interior side of the drive tube, and the threaded surface of the drivable body is on an exterior side of the drivable body.

In some embodiments, the first and second thrust-transfer surfaces are at opposite ends of the drive tube.

In some embodiments, the drivable body comprises a piston nut coupled to the output shaft, the piston nut having the threaded surface of the drivable body.

In some embodiments, the drive body is a drive shaft, the threaded surface of the drive body is on an exterior side of the drive shaft, and the threaded surface of the drivable body is on an exterior side of the drivable body.

In some embodiments, a portion of the housing contacts the output shaft and supports the output shaft radially relative to the drive-body axis of rotation beyond the drive body in a direction along the drive-body axis of rotation and towards a distal end of the output shaft that is positionable outside of the housing.

In some embodiments, the actuator further comprises a motor comprising a motor shaft rotatable relative to the housing around a motor-shaft axis of rotation, wherein the motor is configured to apply a torque directly to the motor shaft and around the motor-shaft axis of rotation, and the motor shaft is coupled to the torque-transfer surface such that rotation of the motor shaft relative to the housing and around the motor-shaft axis of rotation causes rotation of the drive body relative to the housing and around the drive-body axis of rotation.

In some embodiments, the motor-shaft axis of rotation is colinear with a line within the first and second bearings.

In some embodiments, the drive-body axis of rotation and the motor-shaft axis of rotation are coaxial.

In some embodiments, the drive body further comprises a thrust-transfer body comprising the first and second thrust-transfer surfaces, and the threaded surface of the drive body is entirely on a first side of the thrust-transfer body.

In some embodiments, the drive body further comprises a threaded shaft having the threaded surface of the drivable body, and the thrust-transfer body is threadedly coupled to the threaded shaft.

In some embodiments, the drive body further comprises a thrust-transfer body comprising the first and second thrust-transfer surfaces, the motor is on a first side of the thrust-transfer body, and the threaded surface of the drive body is entirely on a second side of the thrust-transfer body opposite the first side of the thrust-transfer body.

In some embodiments, the actuator further comprises at least one gear coupling the motor shaft to the torque-transfer surface.

In some embodiments, at least the first bearing extends, in the radial dimension from the drive-body axis of rotation, beyond the motor and beyond the at least one gear.

In some embodiments, the first bearing is an axial-only bearing, and the second bearing is an axial-only bearing.

In some embodiments, the actuator is devoid of bearing surfaces that are radially opposed relative to the drive-body axis of rotation, that contact any rolling elements of the actuator, and that are positioned to support, directly, the drive body or the drivable body.

In some embodiments, the first and second thrust-transfer surfaces face away from each other.

According to at least one embodiment, there is provided a marine vessel comprising: a transom; a tab hingedly mounted to the transom; and the actuator mounted to the transom and to the tab such that actuation of the actuator actuates the tab between retracted and deployed positions relative to the transom.

In some embodiments, the tab is part of a trim tab assembly or a wake gate assembly.

According to at least one embodiment, there is provided an actuator comprising: a housing; a drive body rotatably coupled to the housing such that the drive body is rotatable relative to the housing around an actuator axis of rotation, the drive body comprising: a first thrust-transfer surface extending transversely to the actuator axis of rotation and facing a first direction along the actuator axis of rotation; a second thrust-transfer surface extending transversely to the actuator axis of rotation and facing a second direction, opposite the first direction, along the actuator axis of rotation; and a torque-transfer surface configured to receive a torque around the actuator axis of rotation to rotate the drive body relative to the housing and around the actuator axis of rotation; a drivable body comprising an output shaft, the drivable body engaged with the drive body such that rotation of the drive body relative to the housing and around the actuator axis of rotation causes movement of the output shaft relative to the housing and along the actuator axis of rotation; a first bearing facing the first thrust-transfer surface and configured to transfer, to the housing, thrust forces from the output shaft in the first direction; and a second bearing facing the second thrust-transfer surface and configured to transfer, to the housing, thrust forces from the output shaft in the second direction; wherein at least the first bearing extends, in a radial dimension from the actuator axis of rotation, beyond the torque-transfer surface.

According to at least one embodiment, there is provided an actuator comprising: an outer body comprising an internal surface defining an internal cavity extending along an actuator axis of rotation, the internal surface comprising at least one engagement portion; an inner body comprising an external surface comprising at least one engagement portion; and at least one ball engaged with the at least one engagement portion of the internal surface of the outer body and with the at least one engagement portion of the external surface of the inner body such that rotation of the outer body relative to the inner body around the actuator axis of rotation causes movement of the inner body relative to the outer body along the actuator axis of rotation, the at least one ball engageable with the internal surface of the outer body within an outer-body-engagement extent along the actuator axis of rotation and the at least one ball engageable with the external surface of the inner body within an inner-body-engagement extent along the actuator axis of rotation, the outer-body-engagement extent along the actuator axis of rotation greater than the inner-body-engagement extent along the actuator axis of rotation.

### BRIEF DESCRIPTION OF THE DRAWINGS

The disclosure will be more readily understood from the following description of the embodiments thereof given, by way of example only, with reference to the accompanying drawings, in which:

FIG. 1 is a perspective view of a marine vessel provided with trim tab assemblies according to one embodiment;

FIG. 2 is an end view of the marine vessel of FIG. 1 showing the trim tab assemblies mounted on a transom thereof;

FIG. 3 is an enlarged view of a port trim tab assembly of the marine vessel of FIG. 1 shown in a retracted configuration;

FIG. 4 is an enlarged view of the port trim tab assembly of the marine vessel of FIG. 1 shown in a deployed configuration;

FIG. 5 is a perspective view of an actuator employed to retract and deploy the port trim tab as shown in FIGS. 3 and 4;

FIG. 6 is a sectional view of the actuator employed to retract and deploy the port trim tab as shown in FIGS. 3 and 4, with the actuator in a retracted position;

FIG. 7 is a sectional view of the actuator employed to retract and deploy the port trim tab as shown in FIGS. 3 and 4, with the actuator in an extended position;

FIG. 8 is an end view of a marine vessel according to another embodiment, showing wake gate assemblies mounted on a transom thereof;

FIG. 9 is an enlarged view of a port wake gate assembly of the marine vessel of FIG. 8 shown in a retracted configuration;

FIG. 10 is an enlarged view of the port wake gate assembly of the marine vessel of FIG. 8 shown in a deployed configuration;

FIG. 11 is a perspective view of an actuator employed to retract and deploy the port wake gate assembly as shown in FIGS. 9 and 10;

FIG. 12 is a sectional view of the actuator employed to retract and deploy the port wake gate assembly as shown in FIGS. 9 and 10, with the actuator in a retracted position;

FIG. 13 is a sectional view of the actuator employed to retract and deploy the port wake gate assembly as shown in FIGS. 9 and 10, with the actuator in an extended position;

FIG. 14 is a sectional view of an actuator according to another embodiment;

FIG. 15 is an enlarged sectional view of the actuator of FIG. 14;

FIG. 16 is a perspective partial sectional view of an actuator according to another embodiment;

FIG. 17 is perspective sectional view of the actuator of FIG. 16;

FIG. 18 is a partial sectional view of the actuator of FIG. 16;

FIG. 19 is a sectional view of the actuator of FIG. 16;

FIG. 20 is an enlarged perspective partial sectional view of the actuator of FIG. 16;

FIG. 21 is an enlarged perspective sectional view of the actuator of FIG. 16;

FIG. 22 is a perspective partial sectional view of an actuator according to another embodiment, which may be used with the actuator of FIG. 16;

FIG. 23 is a perspective sectional view of the actuator of FIG. 22;

FIG. 24 is a partial sectional view of the actuator of FIG. 22;

FIG. 25 is a sectional view of the actuator of FIG. 22;

FIG. 26 is an enlarged perspective partial sectional view of the actuator of FIG. 22;

FIG. 27 is an enlarged perspective sectional view of the actuator of FIG. 22;

FIG. 28 is another enlarged perspective sectional view of the actuator of FIG. 22;

FIG. 29 is a perspective partial sectional view of an actuator according to another embodiment, which may be used with the actuator of FIG. 16;

FIG. 30 is a perspective sectional view of the actuator of FIG. 29;

FIG. 31 is an enlarged perspective partial sectional view of the actuator of FIG. 29;

FIG. 32 is an enlarged perspective sectional view of the actuator of FIG. 29;

FIG. 33 is another enlarged perspective partial sectional view of the actuator of FIG. 29;

FIG. 34 is another enlarged perspective sectional view of the actuator of FIG. 29;

FIG. 35 is a perspective partial sectional view of an actuator according to another embodiment, which may be used with the actuator of FIG. 16;

FIG. 36 is a perspective sectional view of the actuator of FIG. 35;

FIG. 37 is a partial sectional view of the actuator of FIG. 35;

FIG. 38 is a sectional view of the actuator of FIG. 35;

FIG. 39 is an enlarged perspective partial sectional view of the actuator of FIG. 35; and

FIG. 40 is an enlarged perspective sectional view of the actuator of FIG. 35.

### DETAILED DESCRIPTION

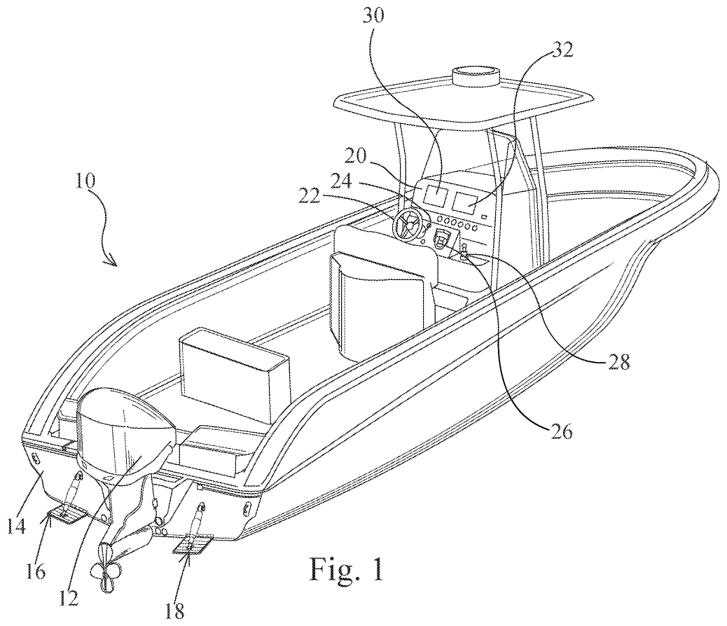

Referring to the drawings and first to FIG. 1, there is shown a marine vessel 10 according to one embodiment and which is provided with a propulsion unit which, in this example, is in the form of an outboard engine 12 mounted on a transom 14 of the marine vessel 10. However, the marine vessel 10 may be provided with any number or form of propulsion units in other examples. The marine vessel 10 is also provided with a port trim tab assembly 16 and a starboard trim tab assembly 18. The port trim tab assembly 16 and the starboard trim tab assembly 18 are each mounted on the transom 14 of the marine vessel 10 in a conventional manner. There is a control station 20 that supports a steering wheel 22 mounted on a helm 24, a control head 26, and a joystick 28. The control station 20 further includes a first display interface 30 and a second display interface 32. In this example, the first display interface 30 is a SIMRAD® display interface which displays navigational information and the second display interface 32 is an OPTIMUS® display which displays onboard system information. The control station 20 allows an operator to steer the outboard engine 12 and deploy and retract the port trim tab assembly 16 and the starboard trim tab assembly 18 in a generally conventional manner.

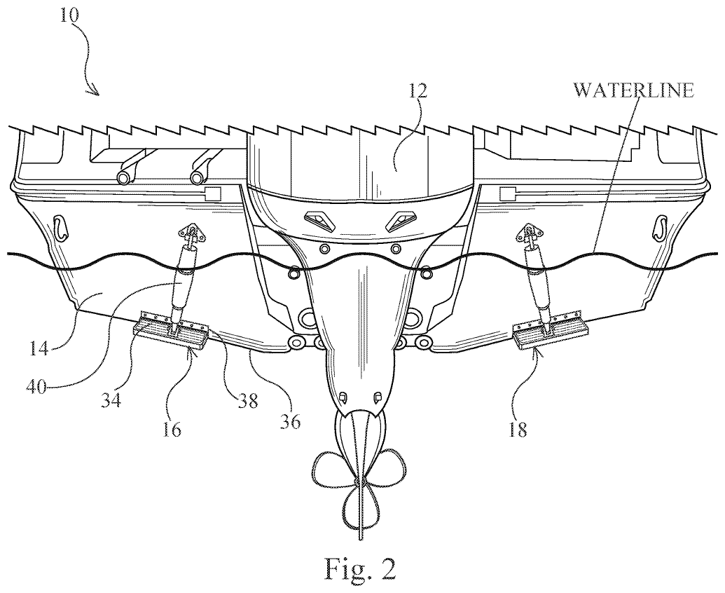

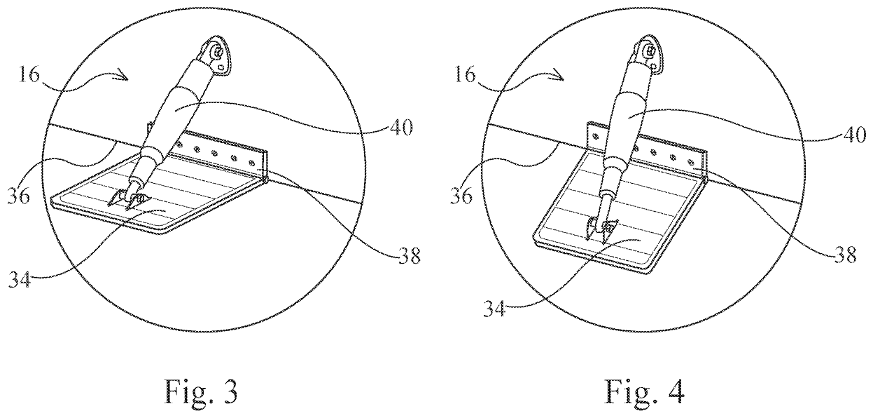

The port trim tab assembly 16 and the starboard trim tab assembly 18 are shown in greater detail in FIG. 2. The port trim tab assembly 16 and the starboard trim tab assembly 18 are substantially the same in structure and function. Accordingly, only the port trim tab assembly 16 is described in detail herein with the understanding that the starboard trim tab assembly 18 has substantially the same structure and function in substantially the same manner. The port trim tab assembly 16 includes a trim tab 34 which is hingedly mounted adjacent a bottom edge 36 of the transom 14 of the marine vessel 10 by a hinge 38. The port trim tab assembly 16 also includes an actuator 40 which actuates the trim tab 34 between a retracted position, as shown in FIG. 3, and a deployed position, as shown in FIG. 4. Referring back to FIG. 2, the actuator 40 may be partially or fully below the waterline and is watertight.

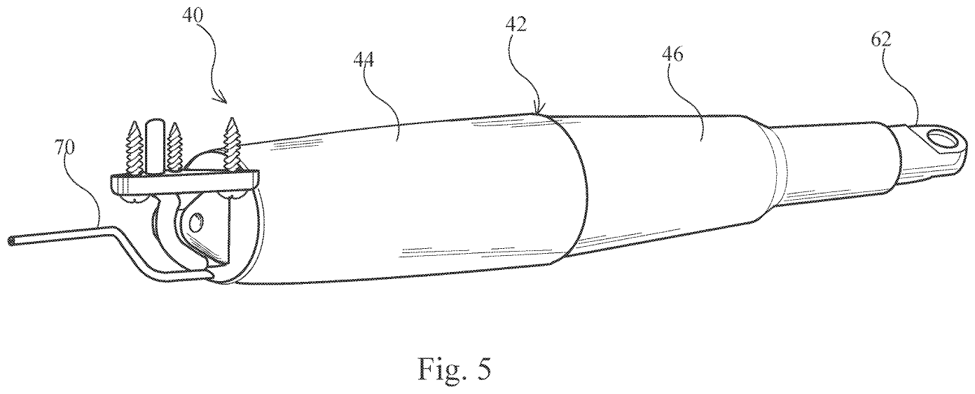

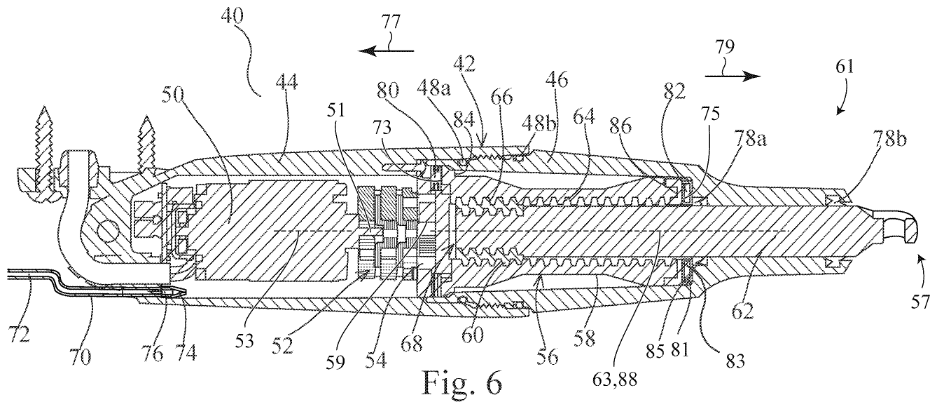

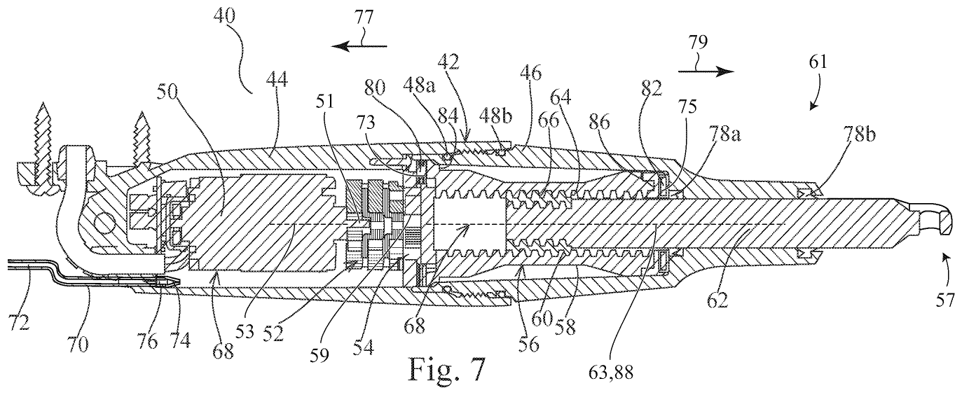

The actuator 40 may be an electric actuator and is shown in greater detail in FIGS. 5 and 6. The actuator 40 generally includes a housing 42 which, in this example, has a first portion 44 and a second portion 46. The first portion 44 of the housing 42 and the second portion 46 of the housing 42 are threadedly connected and there are O-rings 48a and 48b which seal the first portion 44 of the housing 42 and the second portion 46 of the housing 42.

There is a motor 50 disposed in the housing 42. The motor 50 may be electric, for example, and includes a motor shaft 51. The motor 50 may apply a torque directly to the motor shaft 51. For example, the motor 50 may apply a torque to the motor shaft 51 independently of any gears, chains, or belts, and magnetic fields in the motor 50 may directly rotate the motor shaft 51. The motor 50 may apply a torque to the motor shaft 51 around a motor-shaft axis of rotation 53.

The motor shaft 51 is coupled (and thus the motor 50 is coupled) to a planetary gear reduction 52 which includes a last stage planetary gear 54. The last stage planetary gear 54 is coupled to a drive tube assembly 56 which includes a drive tube (or, more generally, a drive body) 58 and a piston nut 60 coupled to an output shaft 62.

The drive tube 58 has a torque-transfer surface 59 engaged with the last stage planetary gear 54. Rotation of the motor shaft 51 relative to the housing 42 and around the motor-shaft axis of rotation 53 causes rotation of the drive tube 58 relative to the housing 42 and around a drive-body axis of rotation 63. The torque-transfer surface 59 is therefore configured to receive a torque around the drive-body axis of rotation 63 to rotate the drive tube 58 relative to the housing 42 and around the drive-body axis of rotation 63.

The output shaft 62 has a distal end shown generally at 57 and positionable outside of the housing 42. A portion shown generally at 61 of the housing 42 contacts the output shaft 62 and supports the output shaft 62 radially relative to the drive-body axis of rotation 63 beyond the drive tube 58 in a direction along the drive-body axis of rotation 63 and towards the distal end 57 of the output shaft 62.

The drive tube 58 has internal threads 64 and the piston nut 60 has external threads 66. A threaded surface of the drive tube 58 defines the internal threads 64, and a threaded surface of the piston nut 60 defines the external threads 66. The internal threads 64 of the drive tube 58 and the external threads 66 of the piston nut 60 are threadedly engaged. Rotation of drive tube 58 accordingly causes the piston nut 60 to reciprocate along a length of the drive tube 58 and the output shaft 62 to reciprocate relative to the housing 42, so that the drive tube 58 may function as a drive body, and one or both of the piston nut 60 and the output shaft 62 may function as a drivable body that is drivable by rotation of the drive tube 58 to cause the output shaft 62 to reciprocate relative to the housing 42. The internal threads 64 of the drive tube 58 and the external threads 66 of the piston nut 60 may be larger in diameter than threads that threadedly engage the piston nut 60 and the output shaft 62. This results in increased thread load carrying capacity.

The diameter of the output shaft 62 may also be decreased to the inner diameter of the drive tube 58. A decreased diameter of the output shaft 62 means a decreased change in an internal volume 68 of the actuator 40 when the output shaft 62 reciprocates relative to the housing 42. The internal volume 68 of the housing 42 increases when the output shaft 62 is extended from the housing 42. The increase in the internal volume 68 of the housing 42 results in a negative air pressure in the housing 42 which is compensated by air flowing into the housing 42 through a vent conduit 70. The vent conduit 70 has a first end 72 in fluid communication with the atmosphere and a second end 74 in fluid communication with the internal volume 68 of the housing 42. There is a check valve 76 disposed at the second end 74 of the vent conduit 70. Air can accordingly flow through the vent conduit 70 into the housing 42 but not out of the housing 42. A positive air pressure is thereby created in the housing 42 when the output shaft 62 is extended and retracted into the housing 42. This restricts the ingress of water into the housing 42. There are also seals 78a and 78b which seal the output shaft 62 against the housing 42 which also restricts the ingress of water into the housing 42. A decreased diameter of the output shaft 62 facilitates sealing.

The drive tube 58 has first and second thrust-transfer surfaces 73 and 75. The first and second thrust-transfer surfaces 73 and 75 extend transversely to the drive-body axis of rotation 63. In the embodiment shown, the first and second thrust-transfer surfaces 73 and 75 extend perpendicularly to the drive-body axis of rotation 63, but alternative embodiments may differ. The first thrust-transfer surface 73 faces a first direction 77 along the drive-body axis of rotation 63. The second thrust-transfer surface 75 faces a second direction 79 along the drive-body axis of rotation 63. The second direction 79 is opposite the first direction 77, and the first and second thrust-transfer surfaces 73 and 75 face away from each other. Also, the first and second thrust-transfer surfaces 73 and 75 are at opposite ends of the drive tube 58. However, alternative embodiments may differ.

The actuator 40 also includes axial bearings 80 and 82 as well as radial bearings 84 and 86 which transfer axial loads and radial loads from the drive tube 58 to the housing 42. This allows for proper load transfer in both the push direction and pull direction. The axial bearing 82 includes rolling elements 81 between bearing surfaces 83 and 85. The axial bearings 80 and 82 may be axial-only bearings.

The axial bearing 80 faces the first thrust-transfer surface 73. The first thrust-transfer surface 73 may be positioned (either permanently or in response to a force on the drive tube 58 in the first direction 77) against the axial bearing 80. Thrust forces on the output shaft 62 in the first direction 77 may be transferred from at least the output shaft 62 to the piston nut 60, from at least the piston nut 60 to the drive tube 58, from at least the first thrust-transfer surface 73 of the drive tube 58 to the axial bearing 80, and from at least the axial bearing 80 to the housing 42. Therefore, the axial bearing 80 is configured to transfer, to the housing 42, thrust forces from the output shaft 62 in the first direction 77.

The axial bearing 82 faces the second thrust-transfer surface 75. The second thrust-transfer surface 75 may be positioned (either permanently or in response to a force on the drive tube 58 in the second direction 79) against the axial bearing 82. Thrust forces on the output shaft 62 in the second direction 79 may be transferred from at least the output shaft 62 to the piston nut 60, from at least the piston nut 60 to the drive tube 58, from at least the second thrust-transfer surface 75 of the drive tube 58 to the axial bearing 82, and from at least the axial bearing 82 to the housing 42. Therefore, the axial bearing 82 is configured to transfer, to the housing 42, thrust forces from the output shaft 62 in the second direction 79.

The axial bearings 80 and 82 extend, in a radial dimension from the drive-body axis of rotation 63, beyond the torque-transfer surface 59, the planetary gear reduction 52, and the motor 50. Further, the motor-shaft axis of rotation 53 is colinear with a line 88 within the bearings 80 and 82, and the motor-shaft axis of rotation 53 and the drive-body axis of rotation 63 are coaxial. However, alternative embodiments may differ. For example, in some embodiments, one or both of the axial bearings 80 and 82 may extend, in a radial dimension from the drive-body axis of rotation 63, beyond none, one, more than one, or all of the torque-transfer surface 59, the planetary gear reduction 52, and the motor 50. Further, the motor-shaft axis of rotation 53 may differ in other embodiments.

The actuator 42 is devoid of bearing surfaces that are radially opposed relative to the drive-body axis of rotation 63, that contact any rolling elements of the actuator 42, and that are positioned to support, directly, the drive tube 58, the piston nut 60, or the output shaft 62.

It is desirable to also have proper load transfer in the pull direction because trim tabs are often employed as steps to get in to and out of marine vessels. It is also desirable to have proper load transfer in both the push direction and pull direction if an actuator is being employed in a wake gate assembly in which the actuator needs to be loaded in both the push direction and the pull direction.

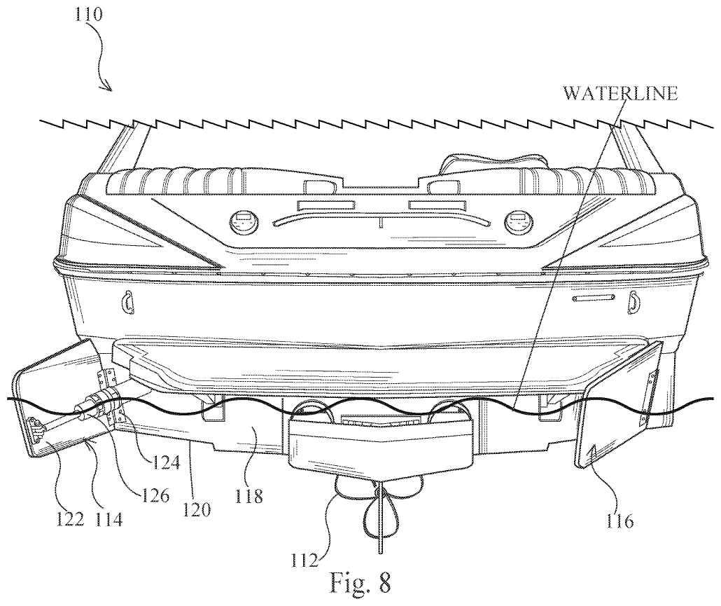

FIG. 8 shows a marine vessel 110 according to another embodiment and provided with a propulsion unit which, in this example, is in the form of an inboard engine 112. However, the marine vessel may be provided with any number or form of propulsion units in other examples. The marine vessel 110 is also provided with a port wake gate assembly 114 and a starboard wake gate assembly 116. The port wake gate assembly 114 and the starboard wake gate assembly 116 are each mounted on a transom 118 of the marine vessel 110 in a conventional manner.

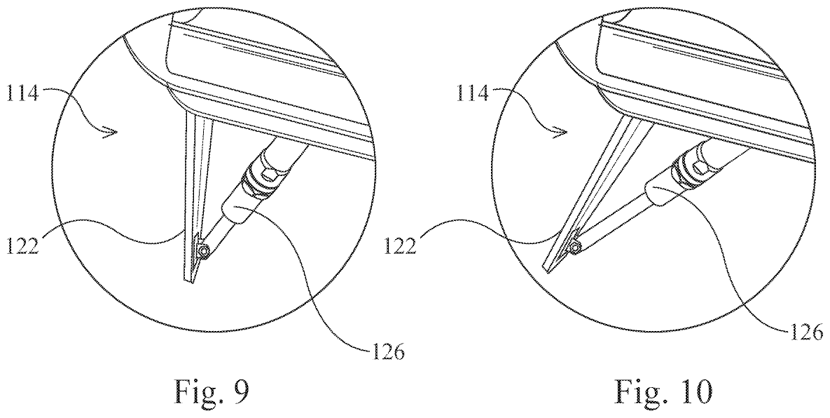

The port wake gate assembly 114 and the starboard wake gate assembly 116 are substantially the same in structure and function. Accordingly, only the port wake gate assembly 114 is described in detail herein with the understanding that the starboard wake gate assembly 116 has substantially the same structure and functions in substantially the same manner. The port wake gate assembly 114 includes a wake tab 122 which is hingedly mounted adjacent a bottom edge 120 of the transom 118 of the marine vessel 110 by a hinge 124. The port wake gate assembly 114 also includes an actuator 126 which actuates the wake tab 122 between a retracted position, as shown in FIG. 9, and a deployed position, as shown in FIG. 10. Referring back to FIG. 8, the actuator 126 may be partially or fully below the waterline and is watertight.

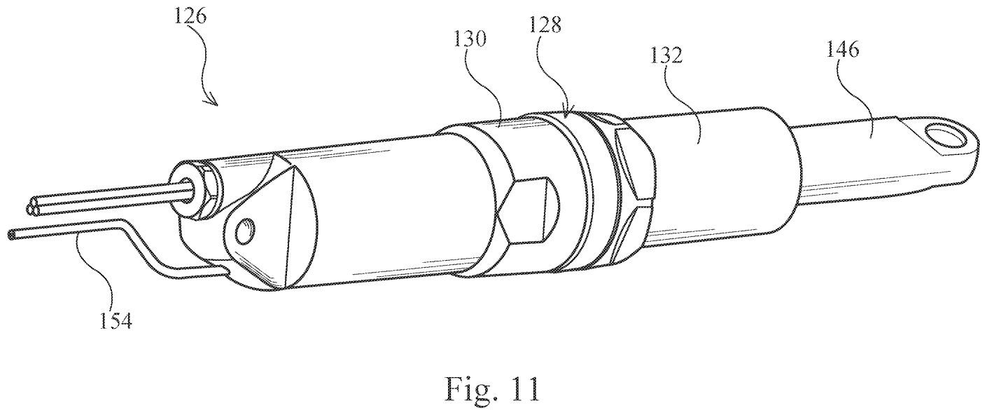

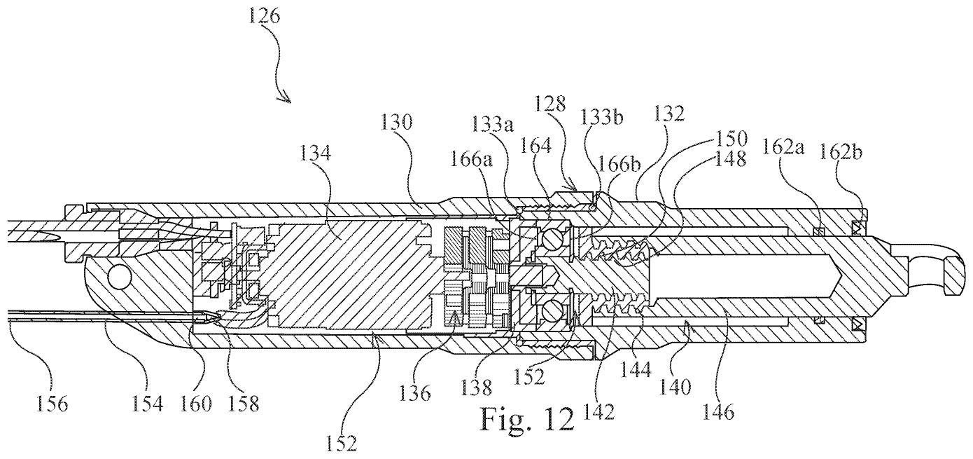

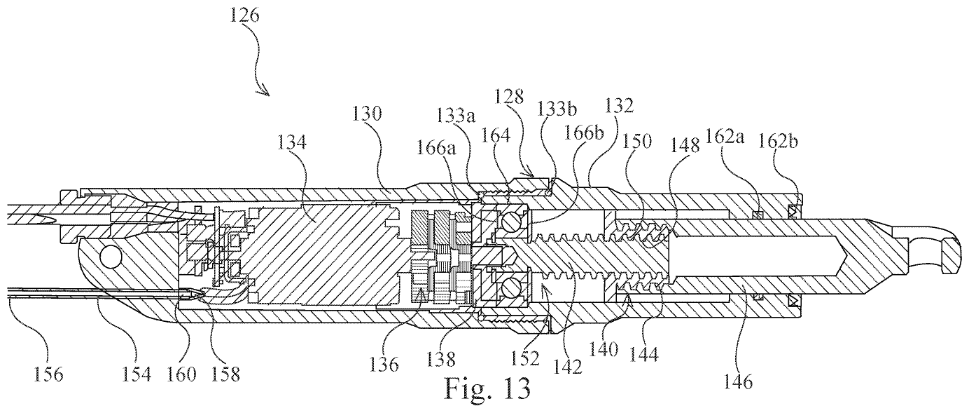

The actuator 126 may be an electric actuator and is shown in greater detail in FIGS. 11 and 12. The actuator 126 generally includes a housing 128 which, in this example, has a first portion 130 and a second portion 132. The first portion 130 of the housing 128 and the second portion 132 of the housing 128 are threadedly connected and there are O-rings 133a and 133b which seal the first portion 130 of the housing 128 and the second portion 132 of the housing 128. There is a motor 134 disposed in the housing 128. The motor 134 is coupled to a planetary gear reduction 136 which includes a last stage planetary gear 138. The last stage planetary gear 138 is coupled to a drive shaft assembly 140 which includes a drive shaft 142 and a piston nut 144 coupled to an output shaft 146. The drive shaft 142 has external threads 148 and the piston nut 144 has internal threads 150. The external threads 148 of the drive shaft 142 and the internal threads 150 of the piston nut 144 are threadedly engaged. The motor 134 rotates the drive shaft 142. Rotation of drive shaft 142 accordingly causes the piston nut 144 to reciprocate along a length of the drive shaft 142 and the output shaft 146 to reciprocate relative to the housing 128. The external threads 148 of the drive shaft 142 and the internal threads 150 of the piston nut 144 may be smaller in diameter than threads that threadedly engage the piston nut 144 and the output shaft 146. This results in increased thread load carrying capacity.

An internal volume 152 of the housing 128 increases when the output shaft 146 is extended from the housing 128. The increase in the internal volume 152 of the housing 128 results in a negative air pressure in the housing 128 which is compensated by air flowing into the housing 128 through a vent conduit 154. The vent conduit 154 has first end 156 in fluid communication with the atmosphere and a second end 158 in fluid communication with the internal volume 152 of the housing 128. There is a check valve 160 disposed at the second end 158 of the vent conduit 154. Air can accordingly flow through the vent conduit 154 into the housing 128 but not out of the housing 128. A positive air pressure is thereby created in the housing 128 when the output shaft 146 is extended and retracted into the housing 128. This restricts the ingress of water into the housing 128. There are also seals 162a and 162b which seal the output shaft 146 against the housing 128 which also restricts the ingress of water into the housing 128. A decreased diameter of the output shaft 146 facilitates sealing.

The actuator 126 also includes bearings 164 which transfer axial loads and radial loads from the drive shaft 142 to the housing 128. The bearings 164 are retained by circlips 166a and 166b in this example. This allows for proper load transfer in both the push direction and pull direction.

It will be understood by a person skilled in the art that the actuator of the trim tab assembly disclosed herein may be employed as part of a wake gate assembly. Likewise, the actuator of the wake gate assembly disclosed herein may be employed as part of a trim tab assembly.

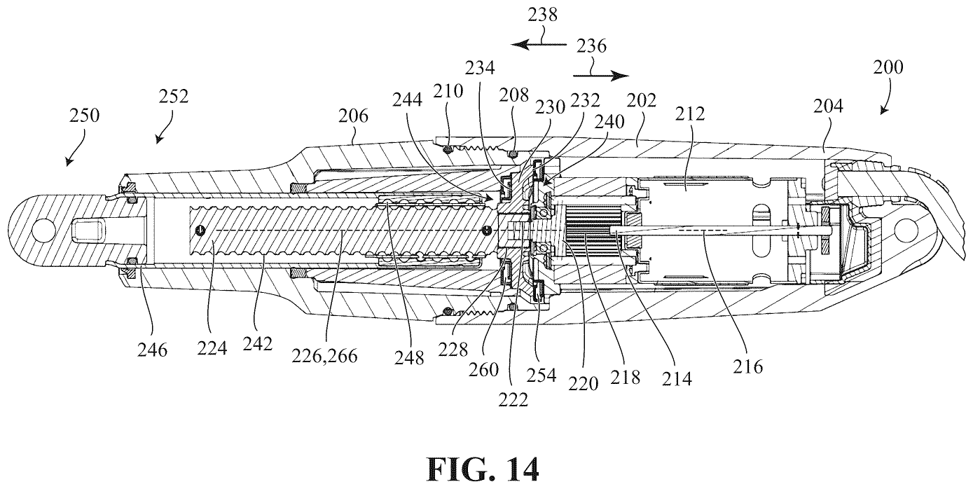

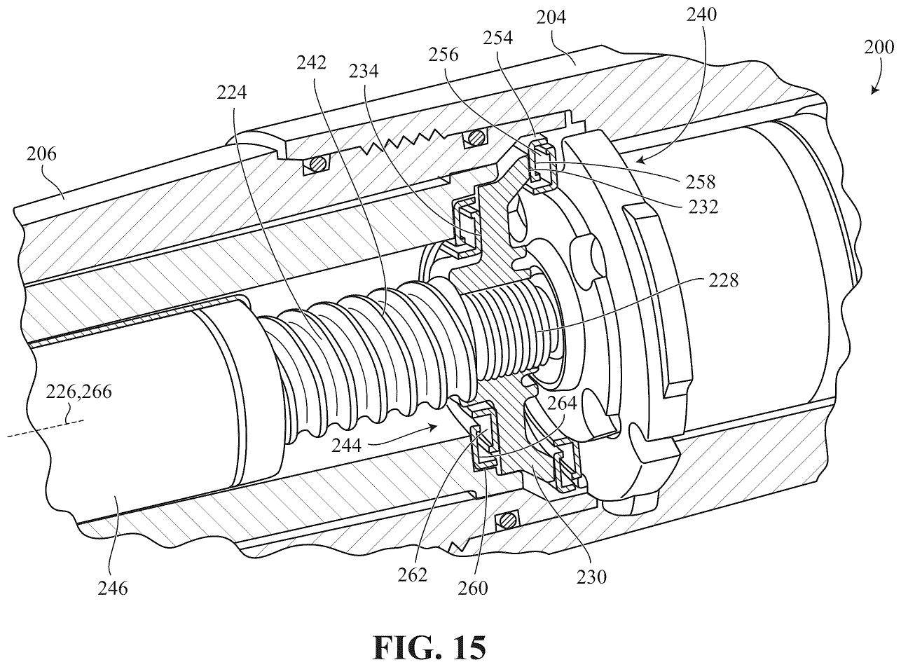

FIGS. 14 and 15 show an actuator shown generally at 200 according to another embodiment. The actuator 200 may be employed as part of a wake gate assembly or as part of a trim tab assembly such as those described above, for example.

The actuator 200 may be an electric actuator and generally includes a housing 202 which, in this example, has a first portion 204 and a second portion 206. The first portion 204 of the housing 202 and the second portion 206 of the housing 202 are threadedly connected and there are O-rings 208 and 210 which seal the first portion 204 of the housing 202 and the second portion 206 of the housing 202.

There is a motor 212 disposed in the housing 202. The motor 202 may be electric, for example, and includes a motor shaft 214. The motor 212 may apply a torque directly to the motor shaft 214. For example, the motor 212 may apply a torque to the motor shaft 214 independently of any gears, chains, or belts, and magnetic fields in the motor 212 may directly rotate the motor shaft 214. The motor 212 may apply a torque to the motor shaft 214 around a motor-shaft axis of rotation 216.

The motor shaft 214 is coupled (and thus the motor 212 is coupled) to one or more gears 218. One of the one or more gears 218 is coupled to a coupling body 220, which is coupled to a torque-transfer surface 222 of a threaded shaft 224. In the embodiment shown, the coupling body 220 defines external threads that are threadedly engaged with internal threads of the torque-transfer surface 222, such that rotation of the motor shaft 214 around the motor-shaft axis of rotation 216 causes rotation of the one or more gears 218, which causes rotation of the coupling body 220, which causes rotation of the threaded shaft 224 around a drive-body axis of rotation 226. The torque-transfer surface 222 is therefore configured to receive a torque around the drive-body axis of rotation 226 to rotate the threaded shaft 224 relative to the housing 202 and around the drive-body axis of rotation 226.

The threaded shaft 224 also defines external threads 228, and at least a portion of the external threads 228 surround at least a portion of the internal threads of the torque-transfer surface 222. A thrust-transfer body 230 defines internal threads that threadedly engage the external threads 228. The thrust-transfer body 230 is thus coupled to the threaded shaft 224 such that axial thrust forces along the drive-body axis of rotation 226 may be transferred from the threaded shaft 224 to the thrust-transfer body 230. Further, the threaded shaft 224 and the thrust-transfer body 230 may collectively function as a drive body. However, in alternative embodiments, the thrust-transfer body 230 may be coupled to the threaded shaft 224 in other ways, or the threaded shaft 224 and the thrust-transfer body 230 may be integrally formed.

The thrust-transfer body 230 has first and second thrust-transfer surfaces 232 and 234. The first and second thrust-transfer surfaces 232 and 234 extend transversely to the drive-body axis of rotation 226. In the embodiment shown, the first and second thrust-transfer surfaces 232 and 234 extend perpendicularly to the drive-body axis of rotation 226, but alternative embodiments may differ. The first thrust-transfer surface 232 faces a first direction 236 along the drive-body axis of rotation 226. The second thrust-transfer surface 234 faces a second direction 238 along the drive-body axis of rotation 226. The second direction 238 is opposite the first direction 236, and the first and second thrust-transfer surfaces 232 and 234 face away from each other. However, alternative embodiments may differ.

The motor 212 is on a first side shown generally at 240 of the thrust-transfer body 230. The threaded shaft 224 has a threaded surface 242 defining external threads, and the threaded surface 242 is entirely on a second side shown generally at 244 of the thrust-transfer body 230, and the second side 244 is opposite the first side 240.

The actuator 200 also includes an output shaft 246 having a threaded surface 248 defining internal threads that are threadedly engaged with the external threads defined by the threaded surface 242, and the housing 202 supports the output shaft 246 for movement relative to the housing 202 along the drive-body axis of rotation 226.

Rotation of threaded shaft 224 accordingly causes the output shaft 246 to reciprocate along a length of the threaded shaft 224, so that the threaded shaft 224 and the thrust-transfer body 230 may function as a drive body, and the output shaft 246 may function as a drivable body that is drivable by rotation of the threaded shaft 224 to cause the output shaft 246 to reciprocate relative to the housing 202.

The output shaft 246 has a distal end shown generally at 250 and positionable outside of the housing 202. A portion shown generally at 252 of the housing 202 contacts the output shaft 246 and supports the output shaft 246 radially relative to the drive-body axis of rotation 226 beyond the threaded shaft 224 in a direction along the drive-body axis of rotation 226 and towards the distal end 250 of the output shaft 246.

The actuator 200 also includes an axial bearing 254 facing the first thrust-transfer surface 232. The axial bearing 254 may include bearing surfaces 256 and 258 that are axially opposed in an axial direction along the drive-body axis of rotation 226, and the axial bearing 254 may include rolling elements between the bearing surfaces 256 and 258. The first thrust-transfer surface 232 may be positioned (either permanently or in response to a force on the threaded shaft 224 in the first direction 236) against the axial bearing 254. Thrust forces on the output shaft 246 in the first direction 236 may be transferred from at least the output shaft 246 to the threaded shaft 224, from at least the threaded shaft 224 to the thrust-transfer body 230, from at least the first thrust-transfer surface 232 of the thrust-transfer body 230 to the axial bearing 254, and from at least the axial bearing 254 to the housing 202. Therefore, the axial bearing 254 is configured to transfer, to the housing 202, thrust forces from the output shaft 246 in the first direction 236. The axial bearing 254 may be an axial-only bearing.

The actuator 200 also includes an axial bearing 260 facing the second thrust-transfer surface 234. The axial bearing 260 may include bearing surfaces 262 and 264 that are axially opposed in an axial direction along the drive-body axis of rotation 226, and the axial bearing 260 may include rolling elements between the bearing surfaces 262 and 264. The second thrust-transfer surface 234 may be positioned (either permanently or in response to a force on the threaded shaft 224 in the second direction 238) against the axial bearing 260. Thrust forces on the output shaft 246 in the second direction 238 may be transferred from at least the output shaft 246 to the threaded shaft 224, from at least the threaded shaft 224 to the thrust-transfer body 230, from at least the second thrust-transfer surface 234 of the thrust-transfer body 230 to the axial bearing 260, and from at least the axial bearing 260 to the housing 202. Therefore, the axial bearing 260 is configured to transfer, to the housing 202, thrust forces from the output shaft 246 in the second direction 238. The axial bearing 260 may be an axial-only bearing.

The axial bearings 254 and 260 extend, in a radial dimension from the drive-body axis of rotation 226, beyond the torque-transfer surface 222, the at least one gear 218, and the motor 212. Further, the motor-shaft axis of rotation 216 is colinear with a line 266 within the bearings 254 and 260, and the motor-shaft axis of rotation 216 and the drive-body axis of rotation 226 are coaxial. However, alternative embodiments may differ. For example, in some embodiments, one or both of the axial bearings 254 and 260 may extend, in a radial dimension from the drive-body axis of rotation 226, beyond none, one, more than one, or all of the torque-transfer surface 222, the at least one gear 218, and the motor 212. Further, the motor-shaft axis of rotation 216 may differ in other embodiments.

The actuator 200 is devoid of bearing surfaces that are radially opposed relative to the drive-body axis of rotation 226, that contact any rolling elements of the actuator 200, and that are positioned to support, directly, the threaded shaft 224, the thrust-transfer body 230, or the output shaft 246.

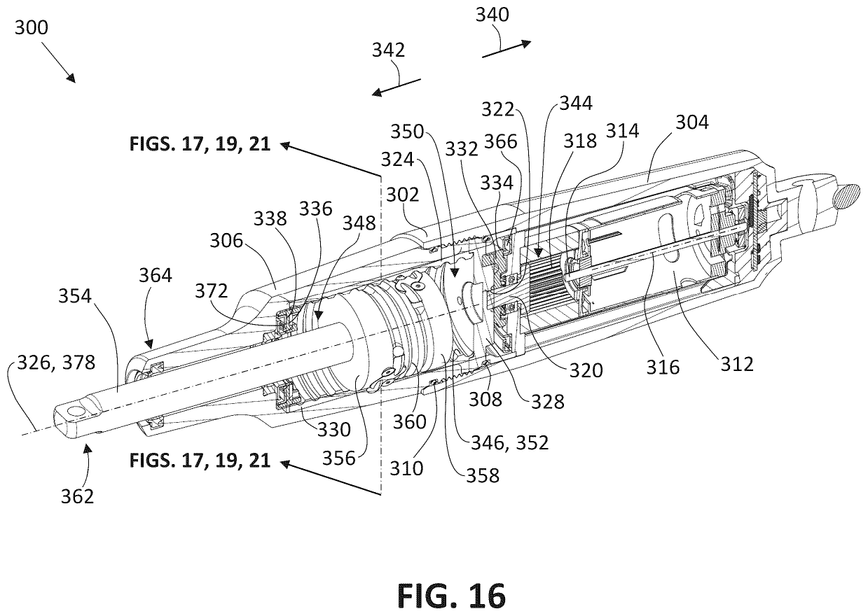

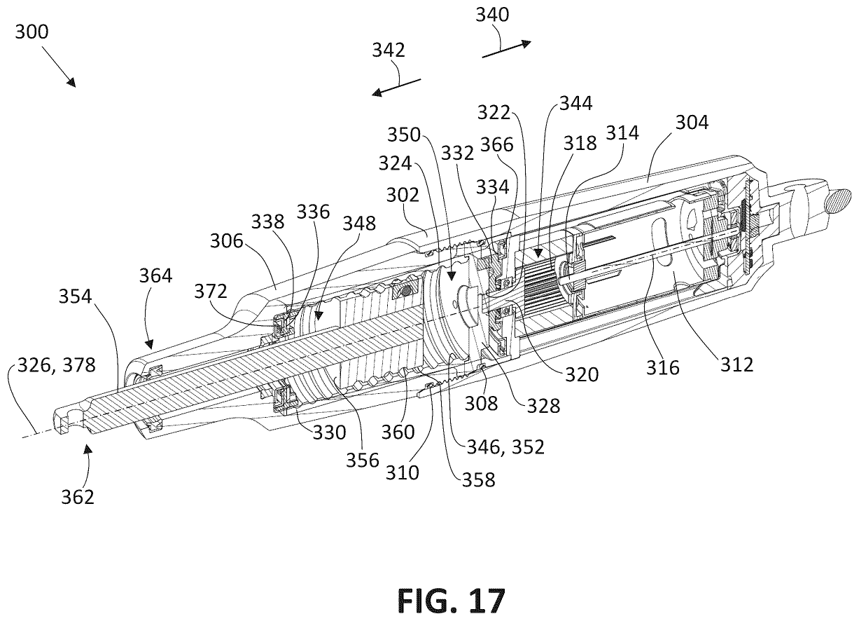

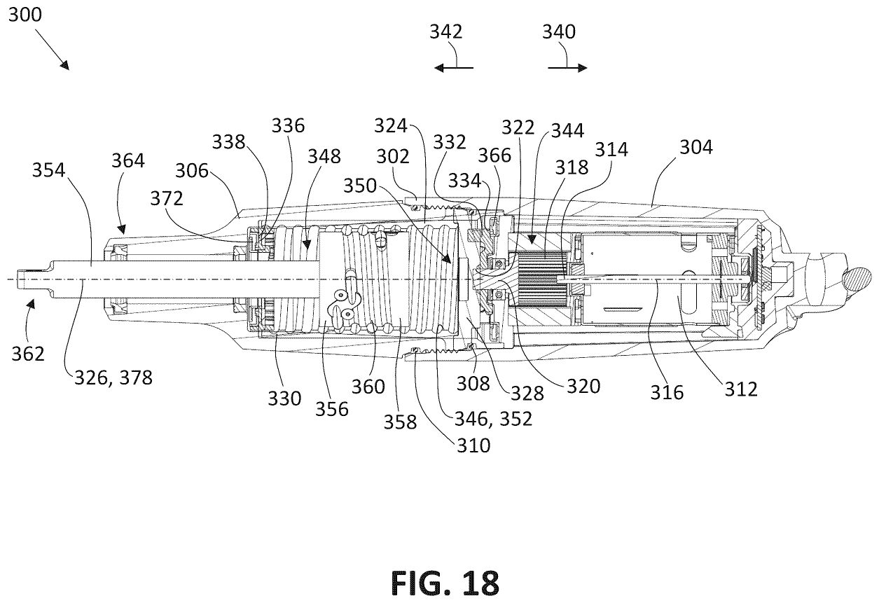

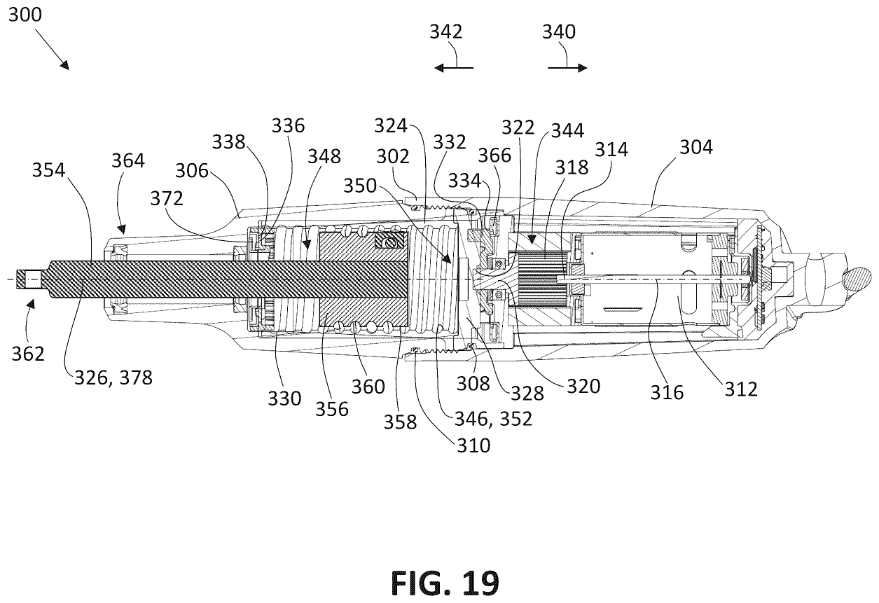

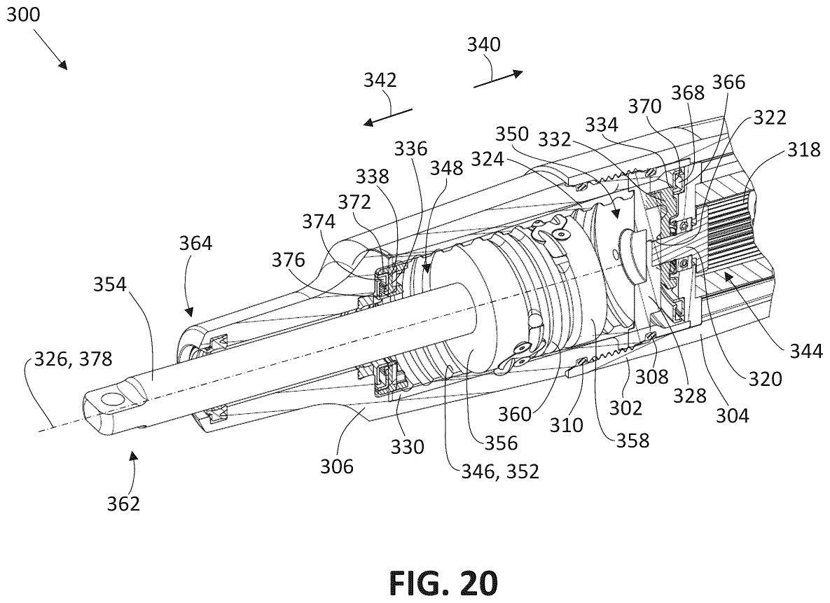

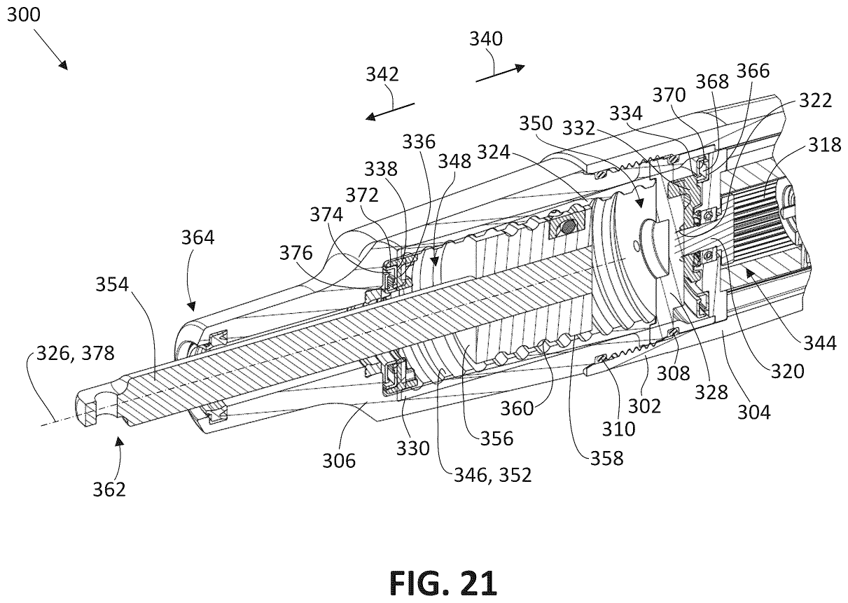

Referring now to FIGS. 16 to 21, an actuator according to another embodiment is shown generally at 300. The actuator 300 may be employed as part of a wake gate assembly or as part of a trim tab assembly such as those described above, for example.

The actuator 300 may be an electric actuator and generally includes a housing 302 which, in this example, has a first portion 304 and a second portion 306. The first portion 304 of the housing 302 and the second portion 306 of the housing 302 are threadedly connected and there are O-rings 308 and 310 which seal the first portion 304 of the housing 302 and the second portion 306 of the housing 302.

There is a motor 312 disposed in the housing 302. The motor 312 may be electric, for example, and includes a motor shaft 314. The motor 312 may apply a torque directly to the motor shaft 314. For example, the motor 312 may apply a torque to the motor shaft 314 independently of any gears, chains, or belts, and magnetic fields in the motor 312 may directly rotate the motor shaft 314. The motor 312 may apply a torque to the motor shaft 314 around a motor-shaft axis of rotation 316.

The motor shaft 314 is coupled (and thus the motor 312 is coupled) to one or more gears 318. One of the one or more gears 318 is coupled to a coupling body 320, which is in turn coupled to a torque-transfer surface 322 of a drive tube 324. For example, the coupling body 320 may define external threads that are threadedly engaged with internal threads of the torque-transfer surface 322. Thus, rotation of the motor shaft 314 around the motor-shaft axis of rotation 316 causes rotation of the one or more gears 318, which causes rotation of the coupling body 320, which causes rotation of the drive tube 324 around an actuator axis of rotation 326. The torque-transfer surface 322 is therefore configured to receive a torque around the actuator axis of rotation 326 to rotate the drive tube 324 relative to the housing 302 and around the actuator axis of rotation 326.

The drive tube 324 includes a first end 328 and a second end 330 opposite the first end 328 along the actuator axis of rotation 326. At the first end 328, the drive tube 324 is coupled to a first thrust-transfer body 332 having a first thrust-transfer surface 334. At the second end 330, the drive tube 324 is coupled to a second thrust-transfer body 336 having a second thrust-transfer surface 338. The first and second thrust-transfer surfaces 334 and 338 extend transversely to the actuator axis of rotation 326. In the embodiment shown, the first and second thrust-transfer surfaces 334 and 338 extend perpendicularly to the actuator axis of rotation 326, but alternative embodiments may differ. The first thrust-transfer surface 334 faces a first direction 340 along the actuator axis of rotation 326. The second thrust-transfer surface 338 faces a second direction 342 along the actuator axis of rotation 326. The second direction 342 is opposite the first direction 340, and the first and second thrust-transfer surfaces 334 and 338 face away from each other. However, alternative embodiments may differ.

The drive tube 324, the first thrust-transfer body 332, and the second thrust-transfer body 336 may collectively function as a drive body. In some alternative embodiments, the drive tube 324 may be integrally formed with the first thrust-transfer body 332 and/or the second thrust-transfer body 336.

The motor 312 is on a first side, shown generally at 344, of the coupling body 320. The drive tube 324 includes an internal surface 346 defining an internal cavity 348 extending along the actuator axis of rotation 326. The internal surface 346 and the internal cavity 348 are entirely on a second side, shown generally at 350, of the coupling body 320, and the second side 350 is opposite the first side 344. The internal surface 346 of the drive tube 324 includes an engagement portion 352.

The actuator 300 also includes an output shaft 354 coupled to a piston 356 located inside the internal cavity 348 of the drive tube 324. The housing 302 supports the output shaft 354 for movement relative to the housing 302 along the actuator axis of rotation 326. The piston 356 includes an external surface 358 having an engagement portion 360. The output shaft 354 and the piston 356 may collectively function as a drivable body.

In general, the engagement portion 360 of the external surface 358 of the piston 356—and thus, the drivable body—is engaged with the engagement portion 352 of the internal surface 346 of the drive tube 324—and thus, the drive body—such that rotation of the drive body and thus the drive tube 324 relative to the housing 302 and around the actuator axis of rotation 326 causes movement of the drivable body and thus the output shaft 354 relative to the housing 302 and along the actuator axis of rotation 326. That is, rotation of the drive tube 324 causes the output shaft 354 to reciprocate along a length of the drive tube 324, such that the drive tube 324 (and the first and second thrust-transfer bodies 332 and 336) may function as a drive body, and the output shaft 354 and the piston 356 may function as a drivable body. In the embodiment shown, the drivable body is engaged with the drive body through one or more balls engaging the engagement portion 352 of the internal surface 346 of the drive tube 324 and the engagement portion 360 of the external surface 358 of the piston 356 such that rotation of the drive tube 324 relative to the housing 302 and around the actuator axis of rotation 326 causes movement of the output shaft 354 relative to the housing 302 and along the actuator axis of rotation 326.

The output shaft 354 has a distal end shown generally at 362 and positionable outside of the housing 302. A portion shown generally at 364 of the housing 302 contacts the output shaft 354 and supports the output shaft 354 radially relative to the actuator axis of rotation 326 beyond the drive tube 324 in a direction along the actuator axis of rotation 326 and towards the distal end 362 of the output shaft 354.

The actuator 300 also includes an axial bearing 366 facing the first thrust-transfer surface 334 of the first thrust-transfer body 332. The axial bearing 366 may include bearing surfaces 368 and 370 that are axially opposed in an axial direction along the actuator axis of rotation 326, and the axial bearing 366 may include rolling elements between the bearing surfaces 368 and 370. The first thrust-transfer surface 334 may be positioned (either permanently or in response to a force on the drive tube 324 in the first direction 340) against the axial bearing 366. Thrust forces on the output shaft 354 in the first direction 340 may be transferred from at least the output shaft 354 to the drive tube 324, from at least the drive tube 324 to the first thrust-transfer body 332, from at least the first thrust-transfer surface 334 of the first thrust-transfer body 332 to the axial bearing 366, and from at least the axial bearing 366 to the housing 302. Therefore, the axial bearing 366 is configured to transfer, to the housing 302, thrust forces from the output shaft 354 in the first direction 340. The axial bearing 366 may be an axial-only bearing.

The actuator 300 also includes an axial bearing 372 facing the second thrust-transfer surface 338 of the second thrust-transfer body 336. The axial bearing 372 may include bearing surfaces 374 and 376 that are axially opposed in an axial direction along the actuator axis of rotation 326, and the axial bearing 372 may include rolling elements between the bearing surfaces 374 and 376. The second thrust-transfer surface 338 may be positioned (either permanently or in response to a force on the drive tube 324 in the second direction 342) against the axial bearing 372. Thrust forces on the output shaft 354 in the second direction 342 may be transferred from at least the output shaft 354 to the drive tube 324, from at least the drive tube 324 to the second thrust-transfer body 336, from at least the second thrust-transfer surface 338 of the second thrust-transfer body 336 to the axial bearing 372, and from at least the axial bearing 372 to the housing 302. Therefore, the axial bearing 372 is configured to transfer, to the housing 302, thrust forces from the output shaft 354 in the second direction 342. The axial bearing 372 may be an axial-only bearing.

The axial bearings 366 and 372 extend, in a radial dimension from the actuator axis of rotation 326, beyond the torque-transfer surface 322. The axial bearings 366 and 372 may also extend, in the radial dimension from the actuator axis of rotation 326, beyond the at least one gear 318 and/or the motor 312. Further, the motor-shaft axis of rotation 316 is colinear with a line 378 within the bearings 366 and 372, and the motor-shaft axis of rotation 316 and the actuator axis of rotation 326 are coaxial. However, alternative embodiments may differ. For example, in some embodiments, one or both of the axial bearings 366 and 372 may extend, in a radial dimension from the actuator axis of rotation 326, beyond none, one, more than one, or all of the torque-transfer surface 322, the at least one gear 318, and the motor 312. Further, the motor-shaft axis of rotation 316 may differ in other embodiments.

The actuator 300 is devoid of bearing surfaces that are radially opposed relative to the actuator axis of rotation 326, that contact any rolling elements of the actuator 300, and that are positioned to support, directly, the drive tube 324, the first thrust-transfer body 332, the second thrust-transfer body 336, or the output shaft 354.

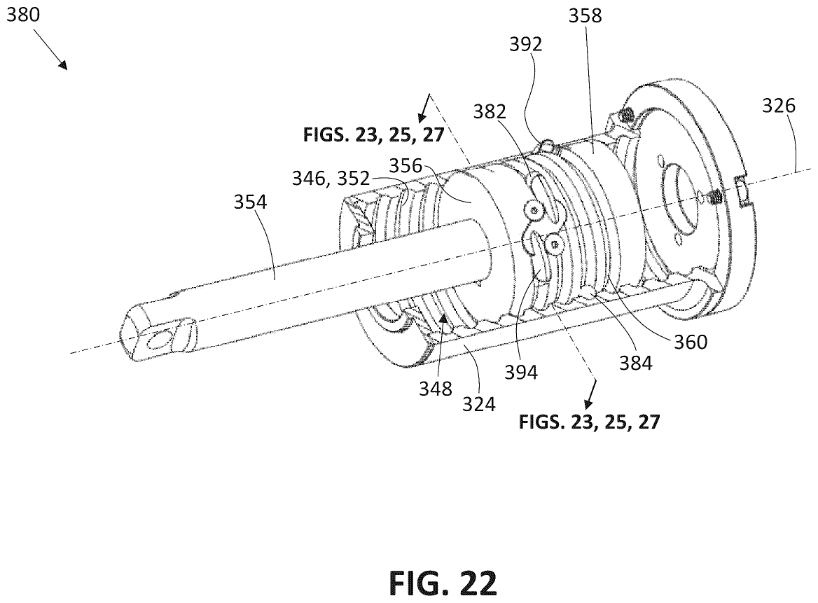

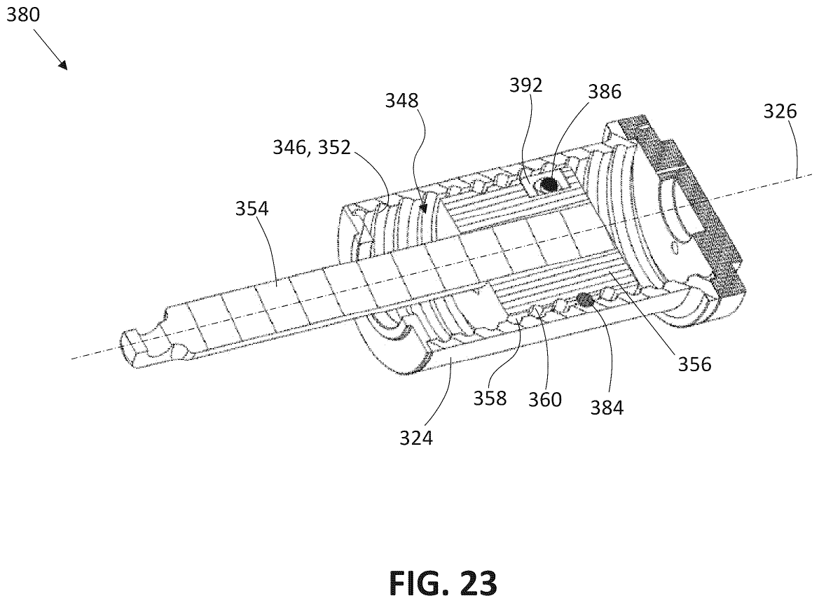

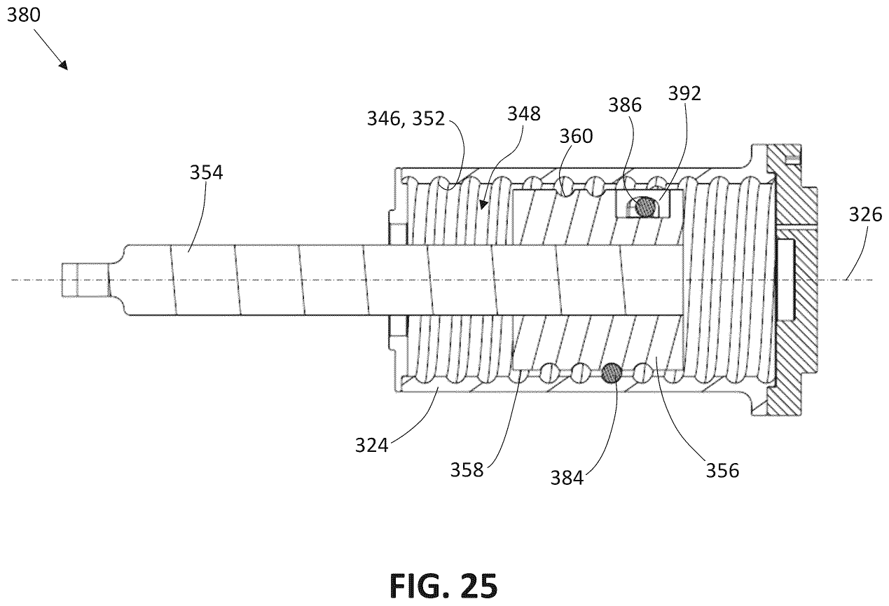

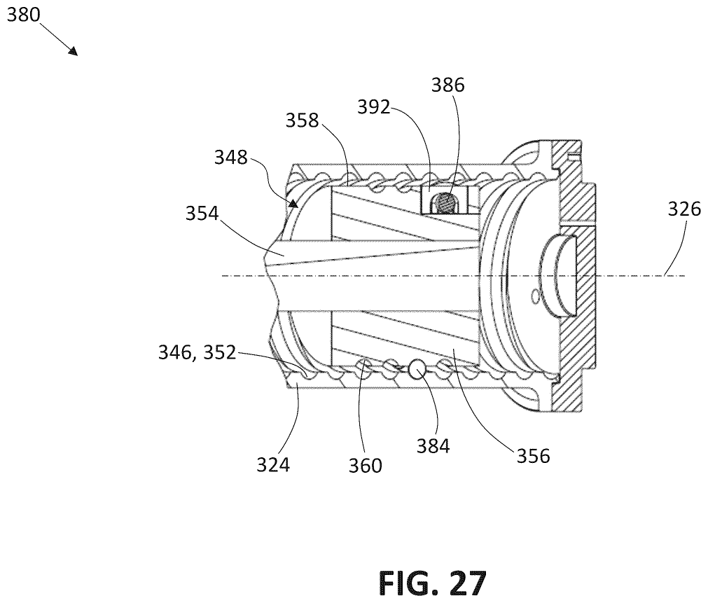

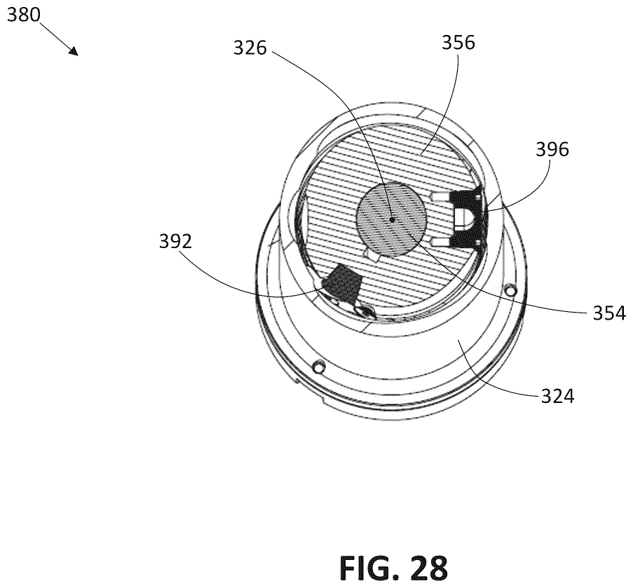

Referring now to FIGS. 16 to 28, the drive body, including at least the drive tube 324, and the drivable body, including at least the piston 356, may themselves be considered to form an actuator 380 when the drive tube 324 of the drive body is engaged with the piston 356 of the drivable body such that rotation of the drive tube 324 relative to the piston 356 and around the actuator axis of rotation 326 causes movement of the piston 356 relative to the drive tube 324 and along the actuator axis of rotation 326. That is, the actuator 380, which in the embodiment shown is a part of the overall actuator 300, includes the drive tube 324 and the piston 356. In some embodiments, the drive tube 324 or the drive body may be referred to as an outer body of the actuator 380, and the piston 356 or the drivable body may be referred to as an inner body of the actuator 380. In the embodiment shown, the drive tube 324 (outer body) and the piston 356 (inner body) are generally cylindrical and concentric. That is, the internal surface 346 of the drive tube 324 is cylindrical with a cylindrical axis colinear with the actuator axis of rotation 326, and the external surface 358 of the piston 356 is also cylindrical with a cylindrical axis colinear with the actuator axis of rotation 326 (and thus with the cylindrical axis of the internal surface 346 of the drive tube 324). However, alternative embodiments may differ.

The actuator 380, and thus the actuator 300, also includes one or more balls through which the drive tube 324 (outer body) engages with the piston 356 (inner body). In the embodiment shown in FIGS. 16 to 28, the actuator 380 includes balls 382, 384, and 386. The balls 382, 384, and 386 may be, for example, bearing balls. In general, the balls 382, 384, and 386 are engaged with the engagement portion 352 of the internal surface 346 of the drive tube 324 (outer body) and with the engagement portion 360 of the external surface 358 of the piston 356 (inner body) such that rotation of the drive tube 324 (outer body) relative to the piston 356 (inner body) around the actuator axis of rotation 326 causes movement of the piston 356 (inner body) relative to the drive tube 324 (outer body) along the actuator axis of rotation 326.

More specifically, in the embodiment shown, the engagement portion 352 of the internal surface 346 of the drive tube 324 includes a threaded surface defining internal threads for engaging the balls 382, 384, and 386, and the engagement portion 360 of the external surface 358 of the piston 356 includes a threaded surface defining external threads for engaging the balls 382, 384, and 386. The piston 356 is positioned inside the internal cavity 348 of drive tube 324, and the balls 382, 384, and 386 are positioned between the engagement portion 352 of the internal surface 346 of the drive tube 324 and the engagement portion 360 of the external surface 358 of the piston 356, such that the balls 382, 384, and 386 may engage both the threads of the engagement portion 352 of the internal surface 346 of the drive tube 324 and the threads of the engagement portion 360 of the external surface 358 of the piston 356. With the balls 382, 384, and 386 engaging both sets of threads, rotation of the drive tube 324 relative to the piston 356 around the actuator axis of rotation 326 causes the balls 382, 384, and 386 to move (e.g., roll) along the threads of the engagement portion 352 of the internal surface 346 of the drive tube 324 and along the threads of the engagement portion 360 of the external surface 358 of the piston 356, thus causing the piston 356 to move relative to the drive tube 324 along the actuator axis of rotation 326.

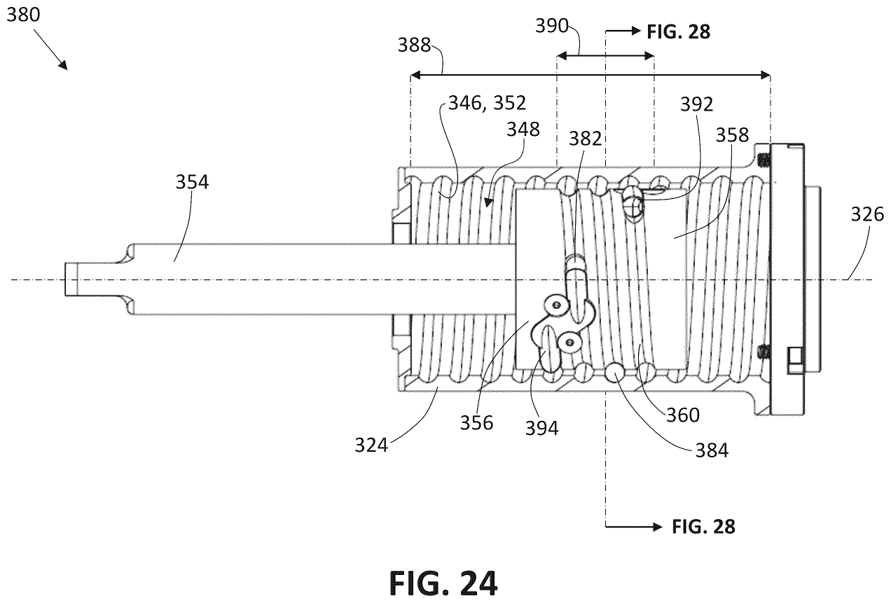

In general, the engagement portion 352 of the internal surface 346 of the drive tube 324 extends further than the engagement portion 360 of the external surface 358 of the piston 356. That is, the balls 382, 384, and 386 are engageable with the engagement portion 352 of the internal surface 346 of the drive tube 324 (outer body) an outer-body-engagement extent 388 along the actuator axis of rotation 326. Likewise, the balls 382, 384, and 386 are engageable with the engagement portion 360 of the external surface 358 of the piston 356 (inner body) an inner-body-engagement extent 390 along the actuator axis of rotation 326. As shown in FIG. 24, the outer-body-engagement extent 388 is greater than the inner-body-engagement extent 390.

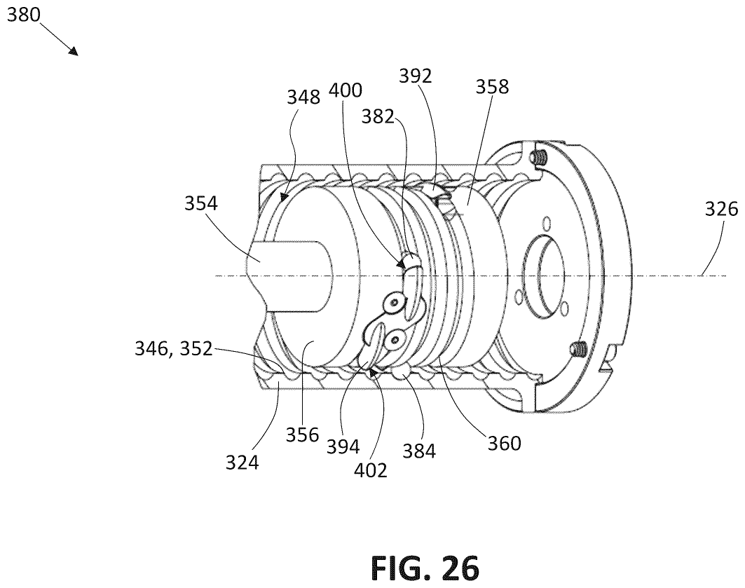

As the piston 356 moves relative to the drive tube 324 along the actuator axis of rotation 326 (e.g., due to rotation of the drive tube 324 relative to the piston 356 around the actuator axis of rotation 326), the balls 382, 384, and 386 also move relative to the piston 356 along the engagement portion 360 of the external surface 358 of the piston 356 and along the actuator axis of rotation 326. Therefore, as the piston 356 moves relative to the drive tube 324 along the actuator axis of rotation 326, the balls 382, 384, and 386 may reach a limit of the inner-body-engagement extent 390—that is, an end of the engagement portion 360. To recirculate the balls 382, 384, and 386 along the engagement portion 360 of the external surface 358 of the piston 356, the piston 356 includes deflectors 392, 394, and 396. Each of the deflectors 392, 394, and 396 is configured to deflect a ball from one location on the threaded surface of the engagement portion 360 to another location on the threaded surface of the engagement portion 360 as the ball moves at and toward the first location. For example, as shown in FIG. 26, the deflector 394 is configured to deflect a ball, such as the ball 382, from a first location 397 on the threaded surface of the engagement portion 360 to a second location 398 on the threaded surface of the engagement portion 360 as the ball 382 moves along the threaded surface of the engagement portion 360 at and toward the first location 397. Similarly, the deflector 394 is also configured to deflect the ball 382 from the second location 398 to the first location 397 as the ball 382 moves along the threaded surface of the engagement portion 360 at and toward the second location 398. In the embodiment shown, the second location 398 is across a thread of the threaded surface of the engagement portion 360 from the first location 397. However, alternative embodiments may include deflectors which deflect balls between locations on the threaded surface of the engagement portion 360 of the external surface 358 of the piston 356 which are across more than one thread of the threaded surface of the engagement portion 360 from each other. Additionally, in the embodiment shown, the deflectors 392, 394, and 396 are positioned on the engagement portion 360 of the external surface 358 of the piston 356 at positions which are approximately 120° apart (i.e., offset by approximately 120°) around the actuator axis of rotation 326. However, alternative embodiments may differ. For example, some alternative embodiments may include a different number of deflectors and/or deflectors which are offset by a different angle around the actuator axis of rotation 326.

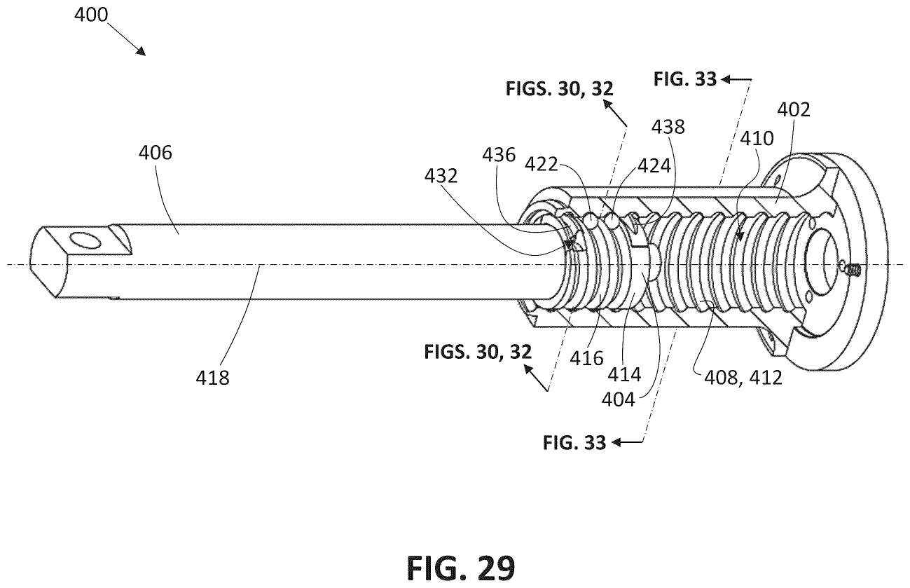

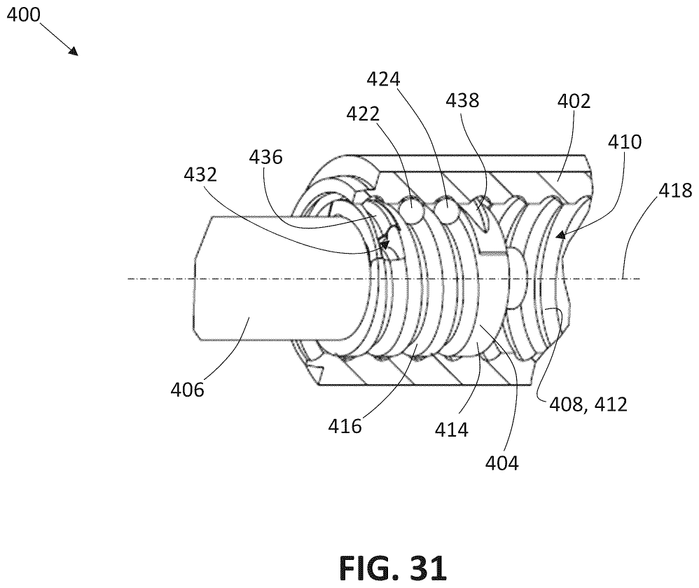

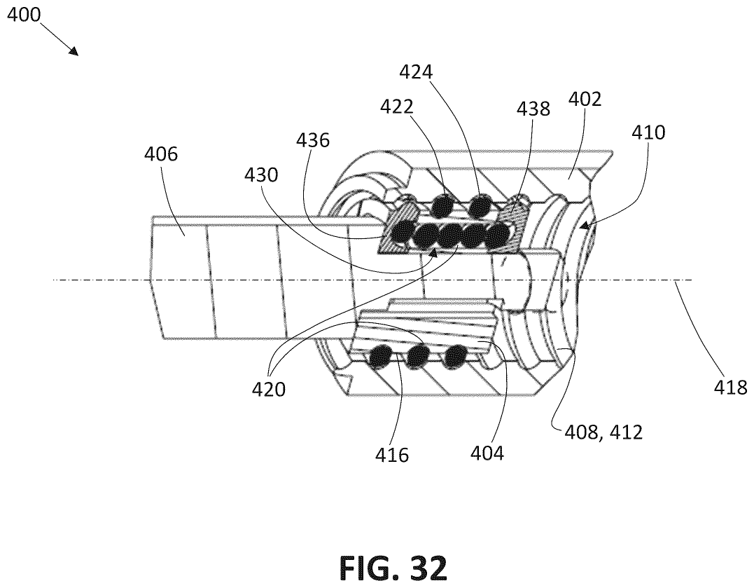

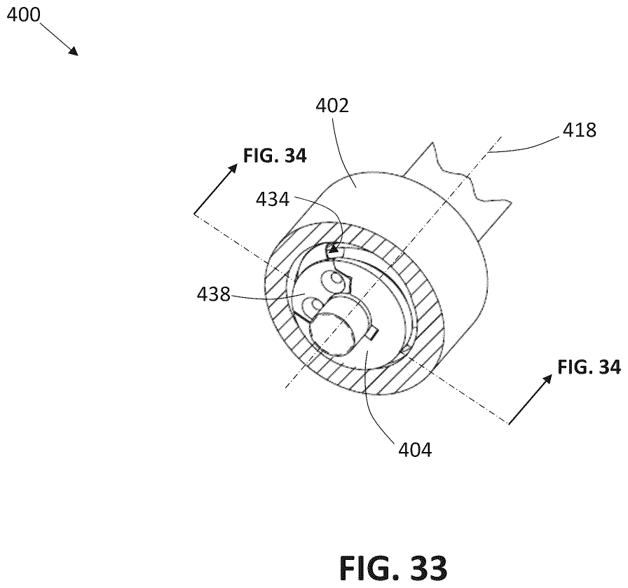

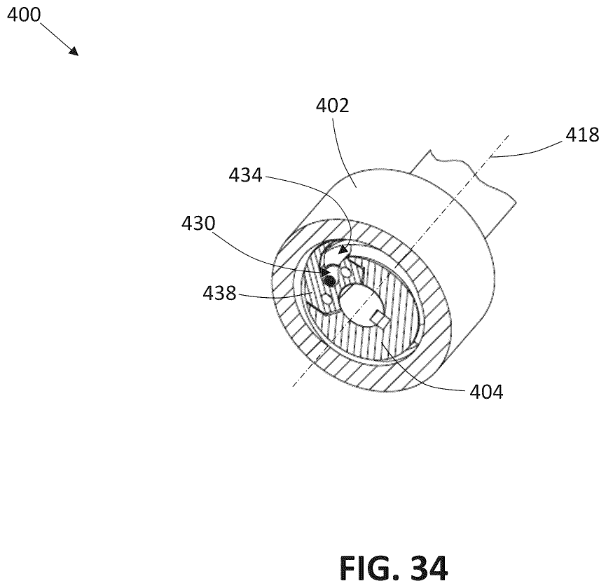

Referring now to FIGS. 29 to 34, an alternative embodiment of an actuator is shown generally at 400. The actuator 400 may be used, for example, in place of the actuator 380 with the actuator 300. The actuator 400 includes a drive tube (outer body) 402 and a piston 404 (inner body) coupled to an output shaft 406, which may be similar to the output shaft 354 of the embodiment of FIGS. 16 to 28. The drive tube 402 may be similar to the drive tube 324 of the embodiment of FIGS. 16 to 28, and includes an internal surface 408 which defines an internal cavity 410 and includes an engagement portion 412. Similarly, the piston 404 may be similar to the piston 356 of the embodiment of FIGS. 16 to 28, and includes an external surface 414 which includes an engagement portion 416.

As in the embodiment of FIGS. 16 to 28, the actuator 400 also includes one or more balls through which the drive tube 402 engages with the piston 404 such that rotation of the drive tube 402 relative to the piston 404 and around an actuator axis of rotation 418 causes movement of the piston 404 relative to the drive tube 402 and along the actuator axis of rotation 418. More specifically, the actuator 400 includes a plurality of balls 420, including balls 422 and 424. These balls may be similar to the balls 382, 384, and 386 of the embodiment of FIGS. 16 to 28.

In general, the plurality of balls 420 are engaged with the engagement portion 412 of the internal surface 408 of the drive tube 402 and with the engagement portion 416 of the external surface 414 of the piston 404 such that rotation of the drive tube 402 relative to the piston 404 around the actuator axis of rotation 418 causes movement of the piston 404 relative to the drive tube 402 along the actuator axis of rotation 418. More specifically, in the embodiment shown, the engagement portion 412 of the internal surface 408 of the drive tube 402 includes a threaded surface defining internal threads for engaging the plurality of balls 420, and the engagement portion 416 of the external surface 414 of the piston 404 includes a threaded surface defining external threads for engaging the plurality of balls 420. The piston 404 is positioned inside the internal cavity 410 of drive tube 402, and the plurality of balls 420 are positioned between the engagement portion 412 of the internal surface 408 of the drive tube 402 and the engagement portion 416 of the external surface 414 of the piston 404, such that the plurality of balls 420 may engage both the threads of the engagement portion 412 of the internal surface 408 of the drive tube 402 and the threads of engagement portion 416 of the external surface 414 of the piston 404. With the plurality of balls 420 engaging both sets of threads, rotation of the drive tube 402 relative to the piston 404 around the actuator axis of rotation 418 causes the plurality of balls 420 to move (e.g., roll) along the threads of the engagement portion 412 of the internal surface 408 of the drive tube 402 and along the threads of the engagement portion 416 of the external surface 414 of the piston 404, thus causing the piston 404 to move relative to the drive tube 402 along the actuator axis of rotation 418.

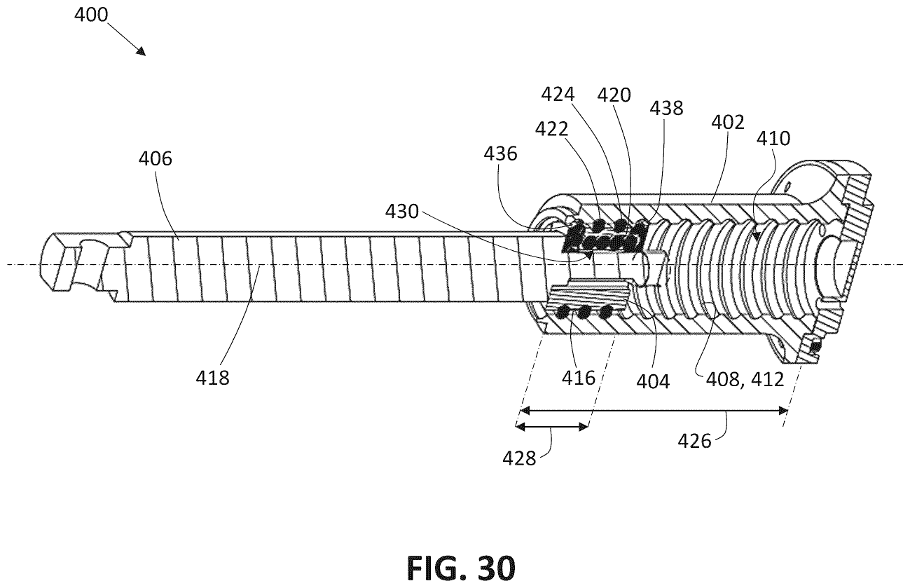

As in the embodiment of FIGS. 16 to 28, the engagement portion 412 of the internal surface 408 of the drive tube 402 extends further than the engagement portion 416 of the external surface 414 of the piston 404. That is, the plurality of balls 420 are engageable with the engagement portion 412 of the internal surface 408 of the drive tube 402 (outer body) an outer-body-engagement extent 426 along the actuator axis of rotation 418. Likewise, the plurality of balls 420 are engageable with the engagement portion 416 of the external surface 414 of the piston 404 (inner body) an inner-body-engagement extent 428 along the actuator axis of rotation 418. As shown in FIG. 30, the outer-body-engagement extent 426 is greater than the inner-body-engagement extent 428.

Also as in the embodiment of FIGS. 16 to 28, as the piston 404 moves relative to the drive tube 402 along the actuator axis of rotation 418 (e.g., due to rotation of the drive tube 402 relative to the piston 404 around the actuator axis of rotation 418), the balls of the plurality of balls 420 also move relative to the piston 404 along the engagement portion 416 of the external surface 414 of the piston 404 and along the actuator axis of rotation 418. Therefore, as the piston 404 moves relative to the drive tube 402 along the actuator axis of rotation 418, the balls of the plurality of balls 420 may reach a limit of the inner-body-engagement extent 428—that is, an end of the engagement portion 416. In this embodiment, to recirculate the balls of the plurality of balls 420 along the engagement portion 416 of the external surface 414 of the piston 404, the piston 404 defines an internal channel 430 extending between a first opening 432 on the threaded surface of the engagement portion 416 of the external surface 414 and a second opening 434 on the threaded surface of the engagement portion 416 of the external surface 414. The internal channel 430 is generally configured to convey the balls of the plurality of balls 420 through the piston 404 between the first opening 432 and the second opening 434. The piston 404 also includes a first derailer 436 on the engagement portion 416 of the external surface 414 at the first opening 432, and a second derailer 438 on the engagement portion 416 of the external surface 414 at the second opening 434. The first derailer 436 is configured to direct each ball of the plurality of balls 420 into the internal channel 430 through the first opening 432 as that ball moves along the threaded surface of the engagement portion 416 of the external surface 414 of the piston 404 at and toward the first opening 432. Likewise, the second derailer 438 is configured to direct each ball of the plurality of balls 420 into the internal channel 430 through the second opening 434 as that ball moves along the threaded surface of the engagement portion 416 of the external surface 414 of the piston 404 at and toward the second opening 434. The embodiment shown is an example only, and alternative embodiments may differ. For example, in some alternative embodiments, the piston/inner body may include more than one channel and/or more than two derailers.

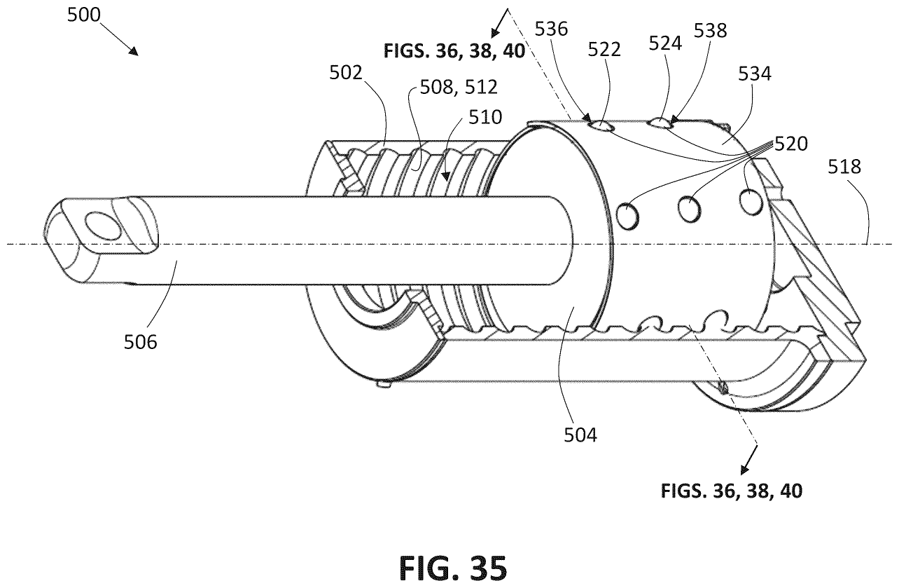

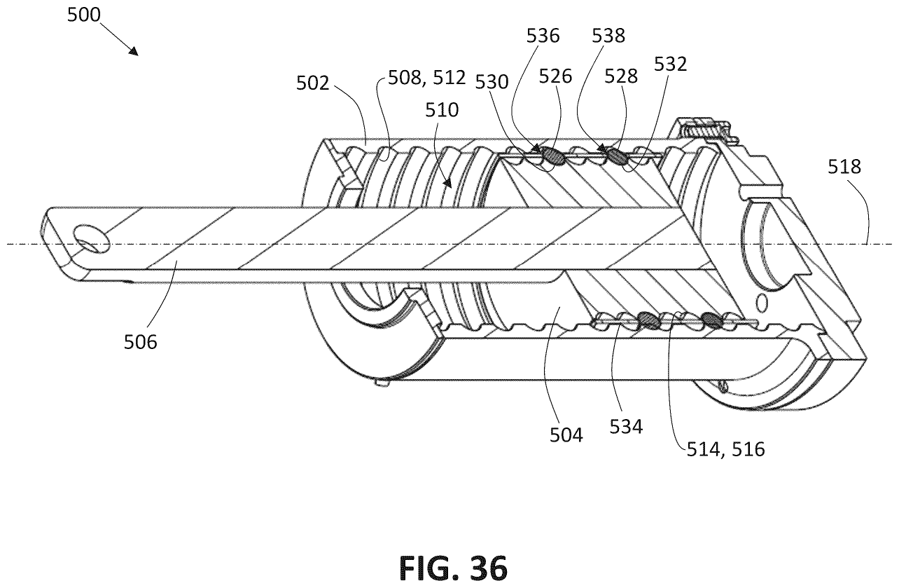

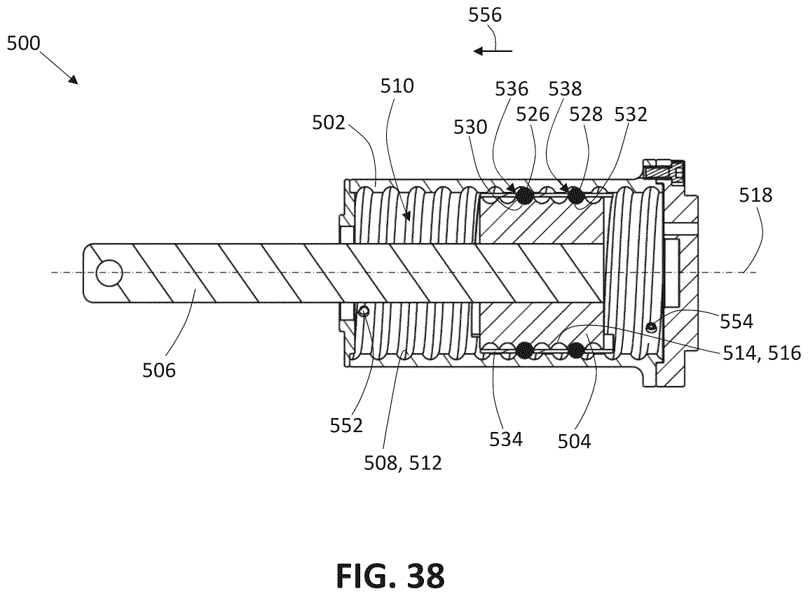

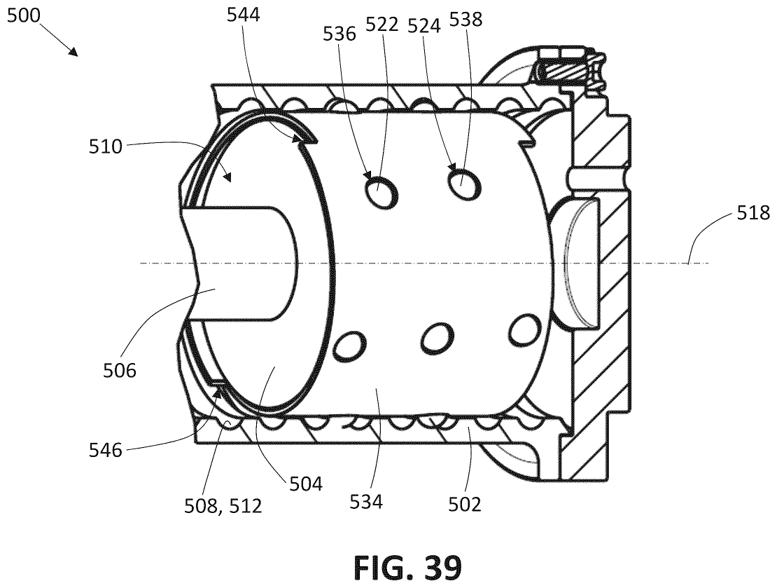

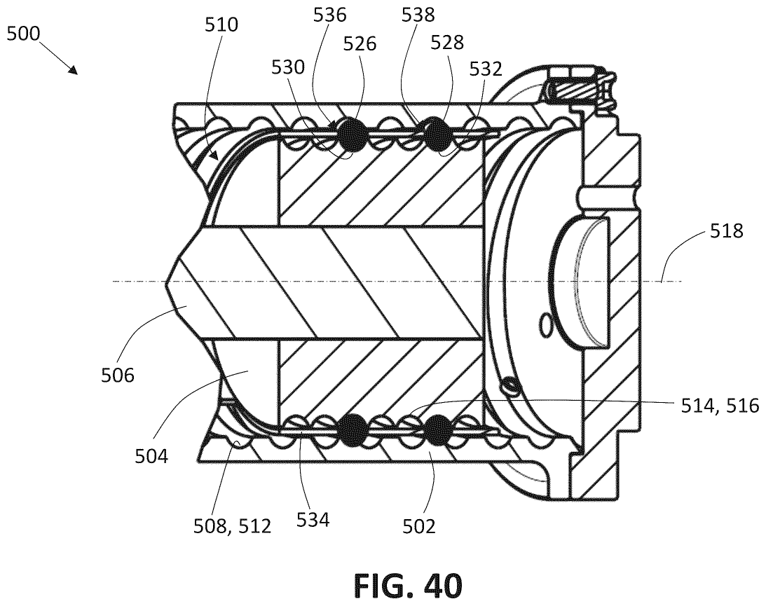

Referring now to FIGS. 35 to 40, an alternative embodiment of an actuator is shown generally at 500. The actuator 500 may be similar to the actuator 400 of the embodiment of FIGS. 29 to 34, and may be used, for example, in place of the actuator 380 with the actuator 300. The actuator 500 includes a drive tube (outer body) 502 and a piston 504 (inner body) coupled to an output shaft 506, which may be similar to the output shaft 354 of the embodiment of FIGS. 16 to 28 and to the output shaft 406 of the embodiment of FIGS. 29 to 34. The drive tube 502 may be similar to the drive tube 324 of the embodiment of FIGS. 16 to 28 and to the drive tube 402 of the embodiment of FIGS. 29 to 34, and includes an internal surface 508 which defines an internal cavity 510 and includes an engagement portion 512. Similarly, the piston 504 may be similar to the piston 356 of the embodiment of FIGS. 16 to 28 and to the piston 404 of the embodiment of FIGS. 29 to 34, and includes an external surface 514 which includes an engagement portion 516.

As in the embodiment of FIGS. 16 to 28, the actuator 500 also includes one or more balls through which the drive tube 502 engages with the piston 504 such that rotation of the drive tube 502 relative to the piston 504 and around an actuator axis of rotation 518 causes movement of the piston 504 relative to the drive tube 502 and along the actuator axis of rotation 518. More specifically, the actuator 500 includes a plurality of balls 520, including balls 522, 524, 526, and 528. These balls may be similar to the balls 382, 384, and 386 of the embodiment of FIGS. 16 to 28, and to the plurality of balls 520 of the embodiment of FIGS. 29 to 34.

In general, the plurality of balls 520 are engaged with the engagement portion 512 of the internal surface 508 of the drive tube 502 and with the engagement portion 516 of the external surface 514 of the piston 504 such that rotation of the drive tube 502 relative to the piston 504 around the actuator axis of rotation 518 causes movement of the piston 504 relative to the drive tube 502 along the actuator axis of rotation 518. More specifically, in the embodiment shown, the engagement portion 512 of the internal surface 508 of the drive tube 502 includes a threaded surface defining internal threads for engaging the plurality of balls 520, and the engagement portion 516 of the external surface 514 of the piston 504 includes a plurality of annular grooves for engaging the plurality of balls 520. For example, the plurality of annular grooves includes the annular groove 530 for engaging the ball 526, and the annular groove 532 for engaging the ball 528.

The piston 504 is positioned inside the internal cavity 510 of drive tube 502, and the plurality of balls 520 are positioned between the engagement portion 512 of the internal surface 508 of the drive tube 502 and the engagement portion 516 of the external surface 514 of the piston 504, such that the plurality of balls 520 may engage both the threads of the engagement portion 512 of the internal surface 508 of the drive tube 502 and the threads of the engagement portion 516 of the external surface 514 of the piston 504. The actuator 500 also includes a ball retainer 534 positioned between threaded surface of the engagement portion 512 of the internal surface 508 of the drive tube 502 and the annular grooves of the engagement portion 516 of the external surface 514 of the piston 504. The ball retainer 534 is rotatable relative to the drive tube 502 around the actuator axis of rotation 518, and is also rotatable relative to the piston 504 around the actuator axis of rotation 518. The ball retainer 534 defines a plurality of through-openings. Each of the through-openings is configured to retain a respective one of the plurality of balls 520 such that that respective ball rotates with the ball retainer 534 around the actuator axis of rotation 518. For example, in the embodiment shown, the plurality of through-openings includes through-opening 536 for retaining the ball 522, and through-opening 538 for retaining the ball 524.

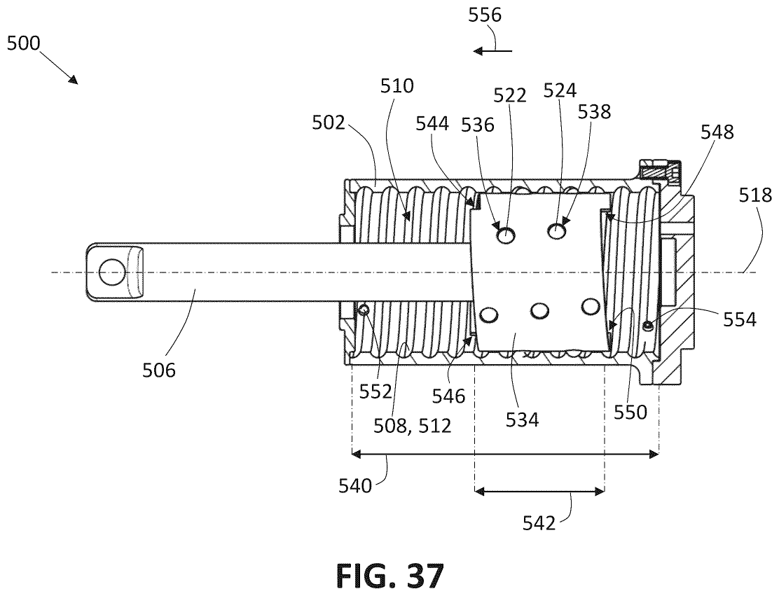

As in the embodiment of FIGS. 16 to 28 and the embodiment of FIGS. 29 to 34, the engagement portion 512 of the internal surface 508 of the drive tube 502 extends further than engagement portion 516 of the external surface 514 of the piston 504. That is, the plurality of balls 520 are engageable with the engagement portion 512 of the internal surface 508 of the drive tube 502 (outer body) an outer-body-engagement extent 540 along the actuator axis of rotation 518. Likewise, the plurality of balls 520 are engageable with engagement portion 516 of the external surface 514 of the piston 504 (inner body) an inner-body-engagement extent 542 along the actuator axis of rotation 518. As shown in FIG. 37, the outer-body-engagement extent 540 is greater than the inner-body-engagement extent 542.

With the plurality of balls 520 engaging both the threads of the drive tube 502 and the annular groves of the piston 504 and retained by the ball retainer 534, rotation of the drive tube 502 relative to the piston 504 around the actuator axis of rotation 518 causes the plurality of balls 520, along with the ball retainer 534, to move (e.g., roll) along the threads of the engagement portion 512 of the internal surface 508 of the drive tube 502 and along the annular grooves of the engagement portion 516 of the external surface 514 of the piston 504, thus causing the piston 504 to move relative to the drive tube 502 along the actuator axis of rotation 518. Unlike the embodiments of FIGS. 16 to 28 and of FIGS. 29 to 34, due to the annular grooves in the engagement portion 516 of the external surface 514 of the piston 504 of the embodiment shown (i.e., as opposed to threads), as the piston 504 of this embodiment moves relative to the drive tube 502 along the actuator axis of rotation 518, the balls of the plurality of balls 520 do not move relative to the piston 504 along the actuator axis of rotation 518—that is, the plurality of balls 520, along with the ball retainer 534, moves with the piston 504 when the piston 504 moves along the actuator axis of rotation 518.

At each end of the ball retainer 534, the ball retainer 534 defines one more recesses. More specifically, in the embodiment shown, the ball retainer 534 defines recesses shown generally at 544, 546, 548, and 550. These recesses allow the drive tube 502 to releasably capture the ball retainer 534 to cause the ball retainer 534 to rotate with the drive tube 502 relative to the piston 504 around the actuator axis of rotation 518. More specifically, the drive tube 502 includes stop pins 552 and 554 projecting into the internal cavity 510 from the internal surface 508 of the drive tube 502. The stop pin 552 of the drive tube 502 may be received into the recess 544 or the recess 546 of the ball retainer 534 to releasably capture the ball retainer 534 to rotate with the drive tube 502 relative to the piston 504 around the actuator axis of rotation 518. Likewise, the stop pin 554 of the drive tube 502 may be received into the recess 548 or the recess 550 of the ball retainer 534 to releasably capture the ball retainer 534 to rotate with the drive tube 502 relative to the piston 504 around the actuator axis of rotation 518. For example, if the drive tube 502 rotates relative to the piston 504 around the actuator axis of rotation 518 to cause the piston 504 and the ball retainer 534 to move relative to the drive tube 502 in a direction 556 along the actuator axis of rotation 518, and the piston 504 and the ball retainer 534 reach the stop pin 552, the stop pin 552 may be received into the recess 544 or the recess 546 of the ball retainer 534 to capture the ball retainer 534 to rotate with the drive tube 502 relative to the piston 504 around the actuator axis of rotation 518 and to stop the movement of the ball retainer 534 (and thus the piston 504) in the direction 556 along the actuator axis of rotation 518.

In general, in embodiments such as those described above, axial bearings (such as the bearings 80, 82, 256, 260, 366, and 372) may be an effective and efficient means of transferring loads of rotating members to a housing (such as the housing 42, 202, or 302). Further, in embodiments such as those described above, use of a housing (such as the housing 42,r 202, or 302) to support an output shaft (such as the output shaft 62, 246, or 354) radially relative to a drive-body axis of rotation may reduce a number of parts of an actuator, which may result in a simpler design over one with dedicated radial bearings.

### CLAUSES

This disclosure includes but is not limited to the following clauses, which may be combined with other subject matter in this specification.
1. An actuator comprising:
   a housing;
   a drive body rotatably coupled to the housing such that the drive body is rotatable relative to the housing around an actuator axis of rotation, the drive body comprising:
      a first thrust-transfer surface extending transversely to the actuator axis of rotation and facing a first direction along the actuator axis of rotation;
      a second thrust-transfer surface extending transversely to the actuator axis of rotation and facing a second direction, opposite the first direction, along the actuator axis of rotation; and
      a torque-transfer surface configured to receive a torque around the actuator axis of rotation to rotate the drive body relative to the housing and around the actuator axis of rotation;
   a drivable body comprising an output shaft, the drivable body engaged with the drive body such that rotation of the drive body relative to the housing and around the actuator axis of rotation causes movement of the output shaft relative to the housing and along the actuator axis of rotation;
   a first bearing facing the first thrust-transfer surface and configured to transfer, to the housing, thrust forces from the output shaft in the first direction; and
   a second bearing facing the second thrust-transfer surface and configured to transfer, to the housing, thrust forces from the output shaft in the second direction;
   wherein at least the first bearing extends, in a radial dimension from the actuator axis of rotation, beyond the torque-transfer surface.
2. The actuator of clause 1 wherein the second bearing extends, in the radial dimension from the actuator axis of rotation, beyond the torque-transfer surface.
3. The actuator of clause 1 or 2 wherein a portion of the housing contacts the output shaft and supports the output shaft radially relative to the actuator axis of rotation beyond the drive body in a direction along the actuator axis of rotation and towards a distal end of the output shaft that is positionable outside of the housing.
4. The actuator of clause 1, 2, or 3 further comprising a motor comprising a motor shaft rotatable relative to the housing around a motor-shaft axis of rotation, wherein the motor is configured to apply a torque directly to the motor shaft and around the motor-shaft axis of rotation, and the motor shaft is coupled to the torque-transfer surface such that rotation of the motor shaft relative to the housing and around the motor-shaft axis of rotation causes rotation of the drive body relative to the housing and around the actuator axis of rotation.
5. The actuator of clause 4 wherein the motor-shaft axis of rotation is colinear with a line within the first and second bearings.
6. The actuator of clause 4 wherein the actuator axis of rotation and the motor-shaft axis of rotation are coaxial.
7. The actuator of clause 4, 5, or 6 further comprising at least one gear coupling the motor shaft to the torque-transfer surface.
8. The actuator of clause 7 wherein at least the first bearing extends, in the radial dimension from the actuator axis of rotation, beyond the motor and beyond the at least one gear.
9. The actuator of any one of clauses 1 to 8 wherein the first bearing is an axial-only bearing, and the second bearing is an axial-only bearing.
10. The actuator of any one of clauses 1 to 9 wherein the first and second thrust-transfer surfaces face away from each other.
11. The actuator of any one of clauses 1 to 10 further comprising at least one ball, wherein the drivable body is engaged with the drive body through the at least one ball such that rotation of the drive body relative to the housing and around the actuator axis of rotation causes movement of the output shaft relative to the housing and along the actuator axis of rotation.
12. The actuator of clause 11 wherein:
   the drive body further comprises an outer body comprising an internal surface defining an internal cavity extending along the actuator axis of rotation, the internal surface comprising at least one engagement portion;
   the drivable body further comprises an inner body coupled to the output shaft, the inner body comprising an external surface comprising at least one engagement portion;
   the at least one ball is engaged with the at least one engagement portion of the internal surface of the outer body and with the at least one engagement portion of the external surface of the inner body such that rotation of the outer body of the drive body relative to the inner body of the drivable body around the actuator axis of rotation causes movement of the inner body relative to the outer body along the actuator axis of rotation;
   the at least one ball is engageable with the internal surface of the outer body with an outer-body-engagement extent along the actuator axis of rotation;
   the at least one ball is engageable with the external surface of the inner body with an inner-body-engagement extent along the actuator axis of rotation; and
   the outer-body-engagement extent along the actuator axis of rotation is greater than the inner-body-engagement extent along the actuator axis of rotation.
13. An actuator comprising:
   an outer body comprising an internal surface defining an internal cavity extending along an actuator axis of rotation, the internal surface comprising at least one engagement portion;
   an inner body comprising an external surface comprising at least one engagement portion; and
   at least one ball engaged with the at least one engagement portion of the internal surface of the outer body and with the at least one engagement portion of the external surface of the inner body such that rotation of the outer body relative to the inner body around the actuator axis of rotation causes movement of the inner body relative to the outer body along the actuator axis of rotation, the at least one ball engageable with the internal surface of the outer body within an outer-body-engagement extent along the actuator axis of rotation and the at least one ball engageable with the external surface of the inner body within an inner-body-engagement extent along the actuator axis of rotation, the outer-body-engagement extent along the actuator axis of rotation greater than the inner-body-engagement extent along the actuator axis of rotation.
14. The actuator of clause 12 or 13 wherein the internal surface of the outer body is cylindrical with a cylindrical axis colinear with the actuator axis of rotation.
15. The actuator of clause 12, 13, or 14 wherein the external surface of the inner body is cylindrical with a cylindrical axis colinear with the actuator axis of rotation.
16. The actuator of any one of clauses 12 to 15 wherein the at least one engagement portion of the internal surface of the outer body comprises a threaded surface.
17. The actuator of clause 16 wherein the at least one engagement portion of the external surface of the inner body comprises at least one annular groove in the external surface.
18. The actuator of clause 17 further comprising a ball retainer between the at least one annular groove of the inner body and the threaded surface of the outer body, the ball retainer defining at least one through-opening retaining the at least one ball such that the at least one ball rotates with the ball retainer around the actuator axis of rotation, wherein:
   the ball retainer is rotatable relative to the inner body around the actuator axis of rotation;
   the ball retainer is rotatable relative to the outer body around the actuator axis of rotation; and
   the ball retainer is releasably capturable by the outer body to rotate with the outer body relative to the inner body around the actuator axis of rotation.
19. The actuator of clause 18 wherein:
   the ball retainer comprises an end defining a recess; and
   the outer body further comprises a stop pin projecting from the threaded surface, the stop pin receivable into the recess to releasably capture the ball retainer to rotate with the outer body relative to the inner body around the actuator axis of rotation.
20. The actuator of any one of clauses 12 to 16 wherein the at least one engagement portion of the external surface of the inner body comprises a threaded surface.
21. The actuator of clause 20 wherein the inner body further comprises at least one deflector configured to deflect the at least one ball from a first location on the threaded surface of the inner body to a second location on the threaded surface of the inner body as the at least one ball moves along the threaded surface of the inner body at and toward the first location, the second location across at least one thread of the threaded surface from the first location.
22. The actuator of clause 21 wherein the at least one deflector is further configured to deflect the at least one ball from the second location to the first location on the threaded surface of the inner body as the at least one ball moves along the threaded surface of the inner body at and toward the second location.
23. The actuator of clause 20, 21, or 22 wherein the inner body defines an internal channel extending through the inner body between a first opening on the threaded surface of the inner body and a second opening on the threaded surface of the inner body, the internal channel configured to convey the at least one ball through the inner body between the first opening and the second opening.
24. The actuator of clause 23 wherein the inner body further comprises a first derailer configured to direct the at least one ball into the internal channel through the first opening as the at least one ball moves along the threaded surface of the inner body at and toward the first opening.
25. The actuator of clause 23 or 24 wherein the inner body further comprises a second derailer configured to direct the at least one ball into the internal channel through the second opening as the at least one ball moves along the threaded surface of the inner body at and toward the second opening.
26. The actuator of any one of clauses 12 to 25 wherein the outer body comprises a drive tube comprising the internal surface.
27. The actuator of any one of clauses 12 to 26 wherein the inner body comprises a piston comprising the external surface.
28. The actuator of any one of clauses 11 to 27 wherein the at least one ball comprises at least one bearing ball.
29. The actuator of any one of clauses 11 to 28 wherein the at least one ball comprises a plurality of balls.
30. A marine vessel comprising:
   a transom;
   a tab hingedly mounted to the transom; and
   the actuator of any one of clauses 1 to 29 mounted to the transom and to the tab such that actuation of the actuator actuates the tab between retracted and deployed positions relative to the transom.
31. The marine vessel of clause 30 wherein the tab is part of a trim tab assembly or a wake gate assembly.

It will be understood by a person skilled in the art that many of the details provided above are by way of example only, and are not intended to limit the scope of the invention which is to be determined with reference to the following claims.

1. An actuator comprising:
a housing;
a drive body rotatably coupled to the housing such that the drive body is rotatable relative to the housing around an actuator axis of rotation, the drive body comprising:
a first thrust-transfer surface extending transversely to the actuator axis of rotation and facing a first direction along the actuator axis of rotation;
a second thrust-transfer surface extending transversely to the actuator axis of rotation and facing a second direction, opposite the first direction, along the actuator axis of rotation; and
a torque-transfer surface configured to receive a torque around the actuator axis of rotation to rotate the drive body relative to the housing and around the actuator axis of rotation;
a drivable body comprising an output shaft, the drivable body engaged with the drive body such that rotation of the drive body relative to the housing and around the actuator axis of rotation causes movement of the output shaft relative to the housing and along the actuator axis of rotation;
a first bearing facing the first thrust-transfer surface and configured to transfer, to the housing, thrust forces from the output shaft in the first direction; and
a second bearing facing the second thrust-transfer surface and configured to transfer, to the housing, thrust forces from the output shaft in the second direction;
wherein at least the first bearing extends, in a radial dimension from the actuator axis of rotation, beyond the torque-transfer surface.

2. The actuator of claim 1 further comprising a motor comprising a motor shaft rotatable relative to the housing around a motor-shaft axis of rotation, wherein the motor is configured to apply a torque directly to the motor shaft and around the motor-shaft axis of rotation, and the motor shaft is coupled to the torque-transfer surface such that rotation of the motor shaft relative to the housing and around the motor-shaft axis of rotation causes rotation of the drive body relative to the housing and around the actuator axis of rotation.

3. The actuator of claim 1 further comprising at least one ball, wherein the drivable body is engaged with the drive body through the at least one ball such that rotation of the drive body relative to the housing and around the actuator axis of rotation causes movement of the output shaft relative to the housing and along the actuator axis of rotation.

4. The actuator of claim 3 wherein:
the drive body further comprises an outer body comprising an internal surface defining an internal cavity extending along the actuator axis of rotation, the internal surface comprising at least one engagement portion;
the drivable body further comprises an inner body coupled to the output shaft, the inner body comprising an external surface comprising at least one engagement portion;
the at least one ball is engaged with the at least one engagement portion of the internal surface of the outer body and with the at least one engagement portion of the external surface of the inner body such that rotation of the outer body of the drive body relative to the inner body of the drivable body around the actuator axis of rotation causes movement of the inner body relative to the outer body along the actuator axis of rotation;
the at least one ball is engageable with the internal surface of the outer body with an outer-body-engagement extent along the actuator axis of rotation;
the at least one ball is engageable with the external surface of the inner body with an inner-body-engagement extent along the actuator axis of rotation; and
the outer-body-engagement extent along the actuator axis of rotation is greater than the inner-body-engagement extent along the actuator axis of rotation.

5. An actuator comprising:
an outer body comprising an internal surface defining an internal cavity extending along an actuator axis of rotation, the internal surface comprising at least one engagement portion;
an inner body comprising an external surface comprising at least one engagement portion; and
at least one ball engaged with the at least one engagement portion of the internal surface of the outer body and with the at least one engagement portion of the external surface of the inner body such that rotation of the outer body relative to the inner body around the actuator axis of rotation causes movement of the inner body relative to the outer body along the actuator axis of rotation, the at least one ball engageable with the internal surface of the outer body within an outer-body-engagement extent along the actuator axis of rotation and the at least one ball engageable with the external surface of the inner body within an inner-body-engagement extent along the actuator axis of rotation, the outer-body-engagement extent along the actuator axis of rotation greater than the inner-body-engagement extent along the actuator axis of rotation.

6. The actuator of claim 5 wherein the internal surface of the outer body is cylindrical with a cylindrical axis colinear with the actuator axis of rotation.

7. The actuator of claim 5 wherein the external surface of the inner body is cylindrical with a cylindrical axis colinear with the actuator axis of rotation.

8. The actuator of claim 5 wherein the at least one engagement portion of the internal surface of the outer body comprises a threaded surface.

9. The actuator of claim 8 wherein the at least one engagement portion of the external surface of the inner body comprises at least one annular groove in the external surface.

10. The actuator of claim 9 further comprising a ball retainer between the at least one annular groove of the inner body and the threaded surface of the outer body, the ball retainer defining at least one through-opening retaining the at least one ball such that the at least one ball rotates with the ball retainer around the actuator axis of rotation, wherein:
the ball retainer is rotatable relative to the inner body around the actuator axis of rotation;
the ball retainer is rotatable relative to the outer body around the actuator axis of rotation; and
the ball retainer is releasably capturable by the outer body to rotate with the outer body relative to the inner body around the actuator axis of rotation.

11. The actuator of claim 10 wherein:
the ball retainer comprises an end defining a recess; and
the outer body further comprises a stop pin projecting from the threaded surface, the stop pin receivable into the recess to releasably capture the ball retainer to rotate with the outer body relative to the inner body around the actuator axis of rotation.

12. The actuator of claim 5 wherein the at least one engagement portion of the external surface of the inner body comprises a threaded surface.

13. The actuator of claim 12 wherein the inner body further comprises at least one deflector configured to deflect the at least one ball from a first location on the threaded surface of the inner body to a second location on the threaded surface of the inner body as the at least one ball moves along the threaded surface of the inner body at and toward the first location, the second location across at least one thread of the threaded surface from the first location.

14. The actuator of claim 13 wherein the at least one deflector is further configured to deflect the at least one ball from the second location to the first location on the threaded surface of the inner body as the at least one ball moves along the threaded surface of the inner body at and toward the second location.

15. The actuator of claim 12 wherein the inner body defines an internal channel extending through the inner body between a first opening on the threaded surface of the inner body and a second opening on the threaded surface of the inner body, the internal channel configured to convey the at least one ball through the inner body between the first opening and the second opening.

16. The actuator of claim 15 wherein the inner body further comprises a first derailer configured to direct the at least one ball into the internal channel through the first opening as the at least one ball moves along the threaded surface of the inner body at and toward the first opening.

17. The actuator of claim 16 wherein the inner body further comprises a second derailer configured to direct the at least one ball into the internal channel through the second opening as the at least one ball moves along the threaded surface of the inner body at and toward the second opening.

18. The actuator of claim 3 wherein the at least one ball comprises at least one bearing ball.

19. The actuator of claim 3 wherein the at least one ball comprises a plurality of balls.

20. A marine vessel comprising:
a transom;
a tab hingedly mounted to the transom; and
the actuator of claim 1 mounted to the transom and to the tab such that actuation of the actuator actuates the tab between retracted and deployed positions relative to the transom.
